(19) United States
(12) Patent Application Publication
(10) Pub. No.: US 2020/0137683 A1
(43) Pub. Date: Apr. 30, 2020

(54) TRAFFIC INDICATION MAP PIGGYBACKING

(71) Applicants: Laurent Cariou, Portland, OR (US); Po-Kai Huang, San Jose, CA (US); Alexander Min, Portland, OR (US); Minyoung Park, San Ramon, CA (US); Rath Vannithamby, Portland, OR (US)

(72) Inventors: Laurent Cariou, Portland, OR (US); Po-Kai Huang, San Jose, CA (US); Alexander Min, Portland, OR (US); Minyoung Park, San Ramon, CA (US); Rath Vannithamby, Portland, OR (US)

(21) Appl. No.: 16/729,150

(22) Filed: Dec. 27, 2019

Related U.S. Application Data
(60) Provisional application No. 62/926,685, filed on Oct. 28, 2019.

(51) Int. Cl. H04W 52/02; H04W 72/04; H04L 1/16

(52) U.S. Cl. CPC H04W 52/0216; H04W 72/0446; H04L 1/1664; H04W 72/0453

(57) ABSTRACT

This disclosure describes systems, methods, and devices related to traffic indication map (TIM) piggybacking. A device may determine a frame including one or more TIMs indicating that the device has data to send in a first frequency band of a plurality of supported frequency bands. The device may cause to send the frame in a second frequency band of the plurality of supported frequency bands, wherein the first frequency band is different from the second frequency band, wherein the frame indicates a request for a first station device to be awake in the first frequency band to receive the data. The device may cause to send the data using the first frequency band.

### CROSS-REFERENCE TO RELATED APPLICATION(S)

This application claims the benefit of U.S. Provisional Application No. 62/926,685, filed Oct. 28, 2019, the disclosure of which is incorporated herein by reference as if set forth in full.

### TECHNICAL FIELD

This disclosure generally relates to systems and methods for wireless communications and, more particularly, to traffic indication map (TIM) piggybacking.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for traffic indication map piggybacking, in accordance with one or more example embodiments of the present disclosure.

FIGS. 1-23 depict illustrative schematic diagrams for traffic indication map piggybacking, in accordance with one or more example embodiments of the present disclosure.

FIG. 24 illustrates a flow diagram of an illustrative process for a traffic indication map piggybacking system, in accordance with one or more example embodiments of the present disclosure.

FIG. 25 illustrates a functional diagram of an exemplary communication station that may be suitable for use as a user device, in accordance with one or more example embodiments of the present disclosure.

FIG. 26 illustrates a block diagram of an example machine upon which any of one or more techniques (e.g., methods) may be performed, in accordance with one or more example embodiments of the present disclosure.

FIG. 27 is a block diagram of a radio architecture in accordance with some examples.

FIG. 28 illustrates an example front-end module circuitry for use in the radio architecture of FIG. 27, in accordance with one or more example embodiments of the present disclosure.

FIG. 29 illustrates an example radio IC circuitry for use in the radio architecture of FIG. 27, in accordance with one or more example embodiments of the present disclosure.

FIG. 30 illustrates an example baseband processing circuitry for use in the radio architecture of FIG. 27, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in or substituted for, those of other embodiments. Embodiments set forth in the claims encompass all available equivalents of those claims.

Traffic indication map (TIM) is an integral part of the power save (PS) mechanisms in the IEEE 802.11 standards. The IEEE recently formed a new Topic Interest Group (TIG) called extremely high throughput (EHT) to develop next-gen Wi-Fi standard specification.

One of the main focus of the next-gen Wi-Fi technology development (e.g., EHT) would be enabling concurrent multi-band (MB) operations. It may be envisioned that both Wi-Fi access point (AP) and client devices (or station, STA) will be multi-band-capable, meaning that Wi-Fi STAs can associate with a Wi-Fi AP on multiple bands, (e.g., 2.4, 5 and 6-7 GHz), and operate on them concurrently. It can be envisioned that an AP could be seen being comprised of multiple collocated APs, wherein each of those APs operates at one of these frequency bands. The same is true for an STA, where an STA can be seen as being comprised of multiple collocated STAs, wherein each of those STAs operates at one of these frequency bands.

For example, an STA can be associated with a multi-band-capable Wi-Fi AP on two frequency bands, (e.g., 5 GHz and 6-7 GHz), and exchange data on those bands independently (i.e., running separate PHY/MAC state machines). In this case, STA's 5 GHz and 6-7 GHz band transceivers will enter/exit power save mode independent to each other and the AP will send TIM in Beacon frames transmitted separately on each band.

When the AP receives data to transmit to an STA on the 5 GHz band, it has to hold the data in a local buffer until the STA wakes up to listen to a Beacon frame, thus introducing a delay in the downlink (DL) data transmission. However, the transceiver on the 6 GHz band in the same STA wakes up earlier to receive the Beacon frame and checks whether there is any data to receive from the AP.

The current IEEE 802.11 standard assumes a single-band operation and TIM conveys the information of the current operating band.

The current TIM element can be used in multi-band operations in the next-gen Wi-Fi, (e.g., layer-2 multi-band aggregation). However, since the TIM can only convey the traffic information of the current operating band (e.g., either 5 GHz or 6-7 GHz band), it cannot leverage potential performance & power benefit from the multi-band operation.

Using MB operations, an MB-capable station device (STA) may be associated with an MB-capable AP over multiple frequency bands (e.g., 2.4, 5 and 6 GHz bands). The MB AP and MB STA may exchange capability information regarding a list of supported frequency bands during association and may use any supported bands concurrently for frame exchanges based on the availability of the bands.

Concurrent device operation on multiple bands may consume more power than single-band operations, for example. Therefore, when the MB STA does not have data to transmit to or receive from the MB AP, the MB STA may be able to enter power save mode (PSM) where the MB STA may enter a low-power (e.g., doze) state and periodically wake up to receive a TIM (Traffic Indication Map) in Beacon frames to determine whether there is data buffered at the MB AP.

The PSM mechanism for multi-band operation defined by the IEEE 802.11 technical standard may be reused. For example, MB STA A may support three frequency bands (e.g., 2.4, 5 and 6 GHz), and may send a Null Data frame with a PM (Power Management) bit set to “1” to indicate a transition to PSM. In PSM, the MB STA periodically may wake up on any of the supported bands to receive Beacons transmitted on any of the supported bands. The MB AP may send separate (e.g., per-band) TIM bitmaps to indicate the presence of buffered data for the MB STA on any respective band. For example, the MB AP may choose to wake up a specific band to deliver data frames based on channel condition, TID, etc. However, such a “baseline” PSM behavior of waking up on all of the supported bands may increase the power consumption. Moreover, such PSM behavior may significantly decrease the frequency and length of device-wide sleep durations, which may have a negative impact not only on a device radio but also on computing/processing and platform level power consumption.

Some IEEE 802.11 PSMs may be designed for single-band operations. For example, when an STA enters a PSM mode, the STA may indicate the PSM transition by setting a 1-bit “Power Management (PM)” subfield to “1” in a Frame Control field of an uplink frame. In PSM, the STA may (i) periodically wake up to receive Beacon frames transmitted by the AP, and (ii) examine the TIM (Traffic Indication Map) element to determine whether there is data to receive from the AP in the current operating band.

Some existing single-band PSM operations may not be sufficient for concurrent multi-band communication scenarios because, for example, single-band PSM operations may not allow the indication of a presence of buffered data on other supported frequency bands. This has implications on MB STAs power consumption in PSM since MB STAs need to periodically wake up and receive Beacons on all of the supported bands. Therefore, devices may benefit from a more efficient PSM mechanism for MB STAs with concurrent multi-band operations.

Concurrent multi-band (MB) operations may enable technologies for next-generation Wi-Fi, i.e., IEEE Extremely High Throughput (EHT). Both next-generation Wi-Fi access points (APs) and station devices (STAs) may be MB-capable, and such MB STAs may associate with MB APs over multiple frequency bands (e.g., 2.4, 5, 6 GHz). An MB STA may exchange frames with the associated MB AP on any supported frequency bands.

Concurrent MB operation may consume more power on a device. To reduce power consumption, an MB STA may switch between an awake state and a doze state on any supported frequency band. For example, the MB STA may send a quality of service (QoS) Null frame or QoS Data frame to an MB AP to indicate that a frequency band in which the frame is transmitted is in the awake state and available to receive data from the AP. However, applying such a mechanism to MB operations might not be sufficient because the mechanism may not fully utilize all the available bands for signaling and because the mechanism may experience unnecessary medium access control (MAC) overhead.

The IEEE 802.11ax technical standard introduced an A-control-field-based Doze Transition Signaling (DTS) mechanism as an efficient means to signal TWT (Target Wake Time) SP (service period) early termination from a non-AP STA to an AP. Compared to some methods of sending management action frames to signal TWT SP early termination, an enhanced method of using a CAS (command and status) subfield in the A-control field for DTS may provide the following benefits. (i) The proposed DTS signaling in the A-control field may be “piggybacked” on to other control and data frames, thus reducing overhead. (ii) The A-control field is parsed in lower-MAC (e.g., as opposed to upper-MAC), so the DTS indication may be quickly processed.

While the DTS mechanism in the IEEE 802.11ax technical standard may allow an STA to opportunistically piggyback a DTS indication on to other control/data frames, the DTS mechanism may not be useful when there is no other on-going frame exchange which may allow piggybacking. The DTS mechanism may not fully utilize the presence of multiple available frequency bands (e.g., 2.4, 5 and 6 GHz), which is envisioned in the IEEE EHT.

While an MB STA may associate with an MB AP over multiple frequency bands, different channels on different frequency bands may asynchronously (or independently) enter/exit power state (e.g., Awake⇄Doze) or become (temporarily) unable due to other reasons (e.g., setting NAV upon detecting OBSS signal).

One way of signaling power state changes in the current operating channel/band (e.g., unscheduled automatic power save delivery (U-APSD)) may have the following limitations. (i) An MB STA may need to wait until the current channel becomes available to indicate the power state changes, which may result in additional latency in state transitions and frame exchanges. (ii) An MB STA may need to exchange additional management (or action) frames (e.g., QoS Null) to indicate power state changes, which may be avoided in multi-band Wi-Fi scenarios.

Some IEEE 802.11 power-save mechanisms may assume single-band operations, where STAs may need to inform power state transitions to the AP by sending a separate QoS Null/Data or management action frame (or using the A-control field) in the current operating channel/band. There is no existing “out-of-band” signaling mechanism which may allow MB STAs to indicate power state transitions of other operating frequency bands.

Some power-save mechanisms require STAs to signal their power state changes in a current operating band. However, such in-band-only signaling mechanisms fail to fully utilize other available bands in multi-band Wi-Fi scenarios. As a result, simply reusing existing power save mechanisms in MB Wi-Fi may experience unnecessary overheads and make power save mechanisms less efficient.

Example embodiments of the present disclosure relate to systems, methods, and devices for piggybacking of traffic indication map (TIM) for energy-efficient multi-band Wi-Fi communications.

In one embodiment, a traffic indication map piggybacking system may facilitate piggybacking band-specific TIM information inside Beacons transmitted on other operating bands. For example, when the AP sends TIM on 6 GHz band, it can piggyback TIM for 5 GHz band, so that multi-band STAs can receive TIM on both bands without waking up both 5 GHz and 6GHz transceivers to receive separate Beacon frames. Note that it may be assumed the 5 and 6-7 GHz transceivers at the STA are inter-connected and their baseband MAC processors can exchange TIM information in real-time. By doing this, the AP can minimize the delay in DL data transmission while minimizing the power consumption of the multi-band STAs.

Another idea is to piggyback the data that is supposed to be delivered over 5 GHz to deliver over 6 GHz as long as enough BW is available and data size is small enough. This may need some more modifications in the higher layers.

In one or more embodiments, a traffic indication map piggybacking system may allow multi-band Wi-Fi APs to opportunistically piggyback TIM information within Beacons frames (or OPS (Opportunistic Power Save) frames) on other bands to its multi-band-associated STAs. For example, if the AP has unicast data to transmit to an STA on 5 GHz band but the Beacon frame transmission on 6 GHz is scheduled earlier than the Beacon transmission on 5 GHz band, the AP piggyback TIM information for 5 GHz band in a Beacon frame transmission on 6 GHz band.

By opportunistically piggybacking TIM information, the AP and STAs can reduce the delay in DL data transmission without causing a higher energy consumption on STAs. Or STAs can save more power while maintaining the same level of delay in DL data transmission.

Example embodiments of the present disclosure relate to systems, methods, and devices for multi-band power saving in wireless communications.

In one or more embodiments, an enhanced MB PSM may be introduced and may require changes to an IEEE 802.11 technical standard. The enhanced MB PSM may allow MB-capable STAs to listen to Beacon frames on one supported frequency band at a time to reduce power consumption and increase sleep state durations. MB APs may send Beacon frames to indicate to associated MB STAs the presence of buffered data not only on the current frequency band but also on other bands so that associated MB STAs may selectively wake up a subset of frequency bands for following data frame exchanges. The enhanced MB PSM may be operable in next-generation Wi-Fi, including using an association identifier (AID) field and MB TIM element formats.

In one or more embodiments, an enhanced MB PSM may have the following attributes. In MB PSM, an MB STA periodically may wake up to receive Beacon frames only on one of the supported bands to check the presence of buffered data on any/all of the supported bands. In order to enable such behavior, Beacon frames transmitted by the MB AP convey not only the regular TIM element to indicate the presence of buffered data on current operating band, but also multi-band TIM element(s) to indicate (i) the presence of buffered data on other frequency bands and/or (ii) the list of target wake-up bands. For example, when an MB AP has data to transmit to an associated MB STA, the MB AP may wake up all supported bands by setting bitmaps in (MB) TIM(s) so that the MB AP may transmit frames in a band which becomes available to reduce latency.

In one or more embodiments, by receiving Beacon frames only on one band at a time, MB STAs may stay in low-power states on other frequency bands for a longer period of time using an enhanced PSM. By indicating a list of target frequency bands to wake up, an AP may flexibly and fully utilize the available resources to optimize performance (e.g., throughput, latency). MB STAs may be allowed to receive AP TIM information on any of the supported bands on which the TIM conveys the traffic bitmap information for all the supported bands. Meanwhile, device transceivers on other bands may stay in low-power states for a longer period of time.

In one or more embodiments, enhanced PSM may introduce a new “MB TIM” element to indicate band-specific TIM bitmap information. MB TIM may be included in Beacon frames sent by an AP in addition to the regular TIM element for the current operating band. For example, Beacon frames may include one regular TIM element for the current operating band (e.g., 2.4 GHz) and two additional MB TIM elements for 5 and 6 GHz bands, or any other bands.

In one or more embodiments, there may be multiple ways to deliver TIM information for multiple frequency bands. One way to deliver TIM on other frequency bands is to include separate TIMs per-band where a TIM bitmap in each band indicates the presence of buffered data on that band. One way to minimize the overhead due to multiple TIM elements is to reduce the size of the bitmap in MB TIM elements. Such may be done by constructing an MB TIM bitmap only for the STAs with bitmap set to “1” in the regular TIM bitmap for the current band. The size of the MB TIM bitmap may be equal to the number of STAs with the bitmap set to “1” in the current frequency band. Another way to design an MB TIM is to assign a separate (or secondary) AID only to MB STAs that support more than one operating band. Such a secondary AID may be used for the purpose of indicating the presence of buffered data on other frequency bands when constructing the MB TIM bitmap. Such may be done by allocating secondary AIDs to MB STAs using one of the “Reserved” bits in a 16-bit AID field. In another option, an MB AP may allocate more than one AID to an MB STA. For example, if the MB STA supports three bands (2.4, 5 and 6 GHz bands), the AP may allocate three consecutive AIDs, n, n+1, n+2 to the STA where AID=n is used in TIM bitmap to indicate the presence of data on 2.4 GHz band, n+1 for 5 GHz band, and n+2 for 6 GHz band. Another option is that MB APs and MB STAs may pre-negotiate wake-up bands before entering MB PSM through, for example, operating mode notification mechanism. When an MB AP has data to transmit to an MB STA, the MB AP may set the TIM bitmap to “1” in Beacons transmitted on any of the supported bands to indicate the presence of buffered data at the AP. Upon the reception of the Beacon with TIM bitmap to “1”, the MB STA may wake up a pre-negotiated list of frequency bands.

Example embodiments of the present disclosure relate to systems, methods, and devices for unscheduled automatic power save delivery (U-APSD) in wireless communications.

In one or more embodiments, enhanced U-APSD methods may allow concurrent MB-capable STAs to piggyback a power state of other frequency bands in a trigger frame, so that devices may signal the power state of the other bands without sending separate QoS Null/Data frames per band. Enhanced U-APSD may allow MB STAs to signal/piggyback power state changes of other operating frequency bands. By enabling out-of-band signaling for power state changes, MB STAs may minimize latency in transitioning between the power states and reduce MAC-layer signaling overhead. For example, such out-of-band signaling may be executed by extending an IEEE 802.11ax Doze Transition Signaling (DTS) mechanism to include a power state transition information of other channels/bands in a CAS (command and status) subfield of the A-control field. With this capability, a U-APSD operation may be extended to multi-band operations by adding three bits (e.g., assuming there are three bands to signal) in a reserved field of a QoS Null or QoS Data frame to indicate to the AP which bands are in the awake state.

In one or more embodiments, enhanced U-APSD may indicate power state changes via out-of-band signaling for MB STAs associated with MB APs over multiple frequency bands. Enhanced U-APSD may include new signaling methods and frame formats to indicate the power state transition of multiple frequency bands.

In one or more embodiments, by enabling out-of-band signaling for power state changes, MB STAs may reduce the latency in transitioning between the power states and may reduce MAC-layer signaling overhead. Enhanced out-of-band signaling mechanisms also may be used in various MB operation scenarios (e.g., to indicate temporal unavailability of the other STAs, such as with network allocation vectors—NAVs).

The above descriptions are for purposes of illustration and are not meant to be limiting. Numerous other examples, configurations, processes, algorithms, etc., may exist, some of which are described in greater detail below. Example embodiments will now be described with reference to the accompanying figures.

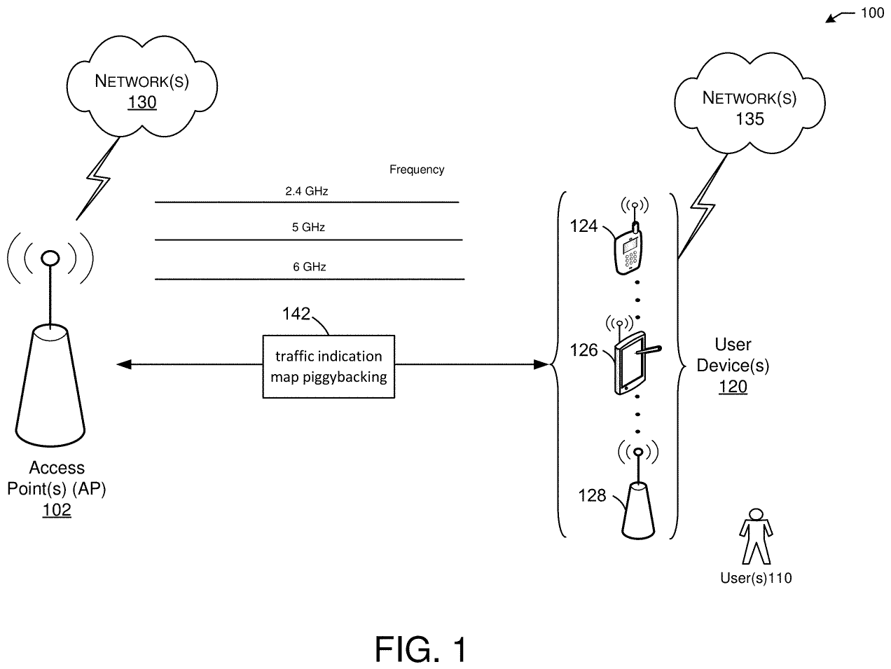

FIG. 1 is a network diagram illustrating an example network environment of traffic indication map piggybacking, according to some example embodiments of the present disclosure. Wireless network 100 may include one or more user devices 120 and one or more access points(s) (AP) 102, which may communicate in accordance with wireless standards, such as, IEEE 802.11 communication standards. The user device(s) 120 may be mobile devices that are non-stationary (e.g., not having fixed locations) or may be stationary devices.

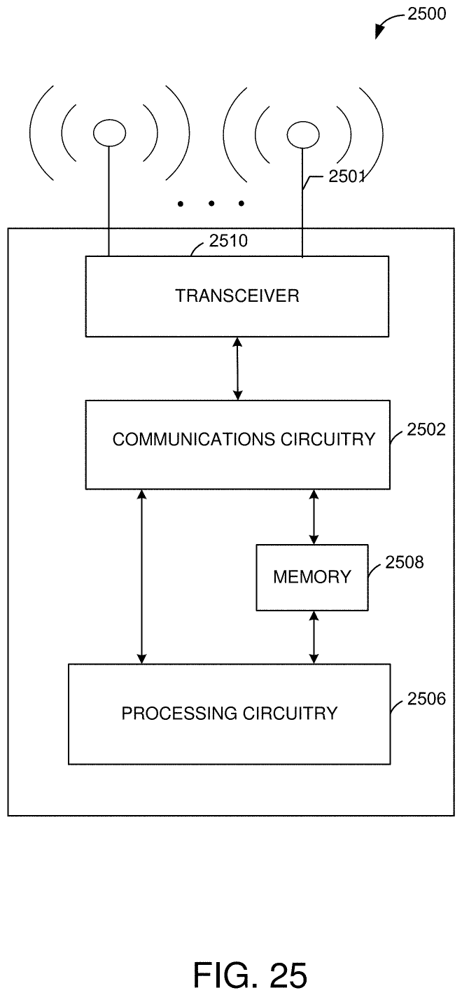

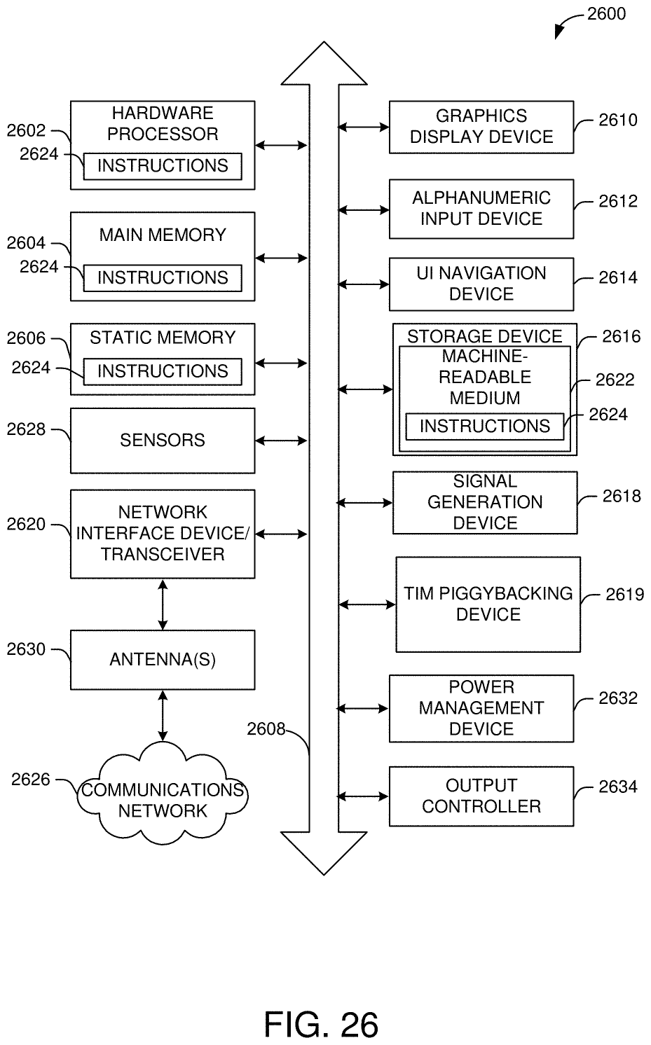

In some embodiments, the user devices 120 and the AP 102 may include one or more computer systems similar to that of the functional diagram of FIG. 25 and/or the example machine/system of FIG. 26.

One or more illustrative user device(s) 120 and/or AP(s) 102 may be operable by one or more user(s) 110. It should be noted that any addressable unit may be a station (STA). An STA may take on multiple distinct characteristics, each of which shapes its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, (e.g., a static device). For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc., may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHZ channels (e.g., 802.11ad, 802.11ay), 800 MHz channels (e.g., 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, AP 102 may facilitate traffic indication map piggybacking 142 with one or more user devices 120.

Concurrent multi-band (MB) operations may enable technologies for next-generation Wi-Fi, i.e., IEEE Extremely High Throughput (EHT). Both next-generation Wi-Fi access points (APs) and station devices (STAs) may be MB-capable, and such MB STAs may associate with MB APs over multiple frequency bands (e.g., 2.4, 5, 6 GHz). An MB STA may exchange frames with the associated MB AP on any supported frequency bands.

In one embodiment, and with reference to FIG. 1, AP 102 and user devices 120 may facilitate a traffic indication map (TIM) piggybacking 142. The TIM piggybacking in an MB operation may be piggybacked using frames that may include Beacon frames, association request and response frames, uplink frames, and any frame which may include a TIM or other information which may be used to determine when to activate device radios.

It is understood that the above descriptions are for purposes of illustration and are not meant to be limiting.

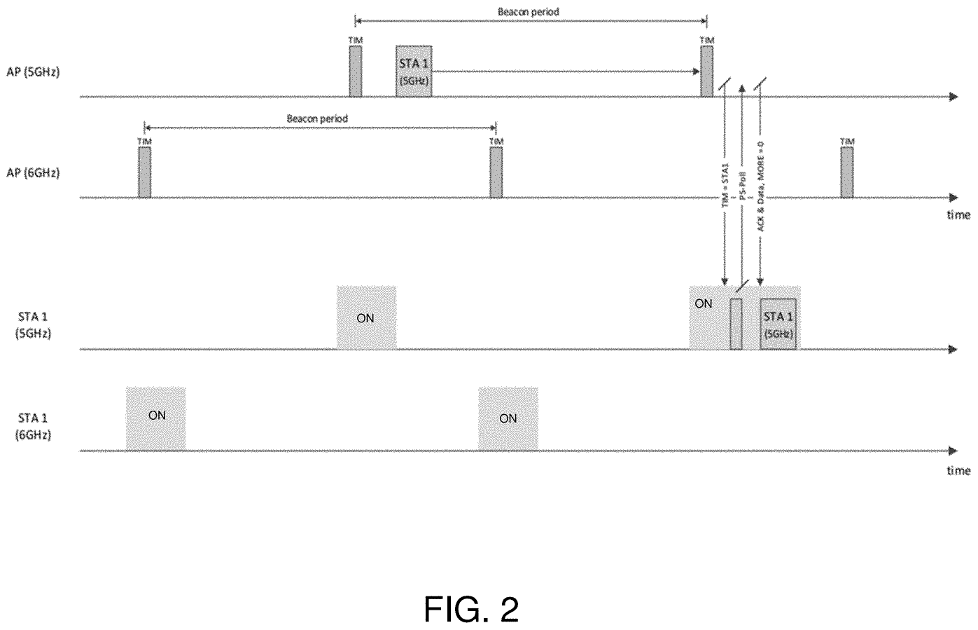

FIGS. 2-24 depict illustrative schematic diagrams for traffic indication map piggybacking, in accordance with one or more example embodiments of the present disclosure.

Referring to FIG. 2, there is shown an example behavior of power save mode (PSM) for multi-band Wi-Fi.

As shown in the FIG. 2, when the AP receives data to transmit to STA 1 on 5 GHz band, it has to hold the data in a local buffer until the STA 1 wakes up to listen to a Beacon frame, thus introducing delay in DL data transmission. However, as shown in FIG. 2, the transceiver on 6 GHz band in the same STA wakes up earlier to receive a Beacon frame and checks whether there is any data to receive from the AP.

Based on this observation, a traffic indication map piggybacking system may facilitate piggybacking band-specific TIM information inside frames such as Beacon frames transmitted on other operating bands. For example, when the AP sends TIM on 6 GHz band, it can piggyback TIM for 5 GHz band, so that multi-band STAs can receive TIM on both bands without waking up both 5 GHz and 6 GHz transceivers to receive separate Beacon frames. Note that it may be assumed that the 5 and 6-7 GHz transceivers at the STA are inter-connected and their baseband MAC processors can exchange TIM information in real-time. By doing this, the AP can minimize the delay in DL data transmission while minimizing the power consumption of the multi-band STAs.

Another idea is to piggyback the data that is supposed to be delivered over 5 GHz to deliver over 6 GHz as long as enough BW is available and data size is small enough. This may need some more modifications in the higher layers.

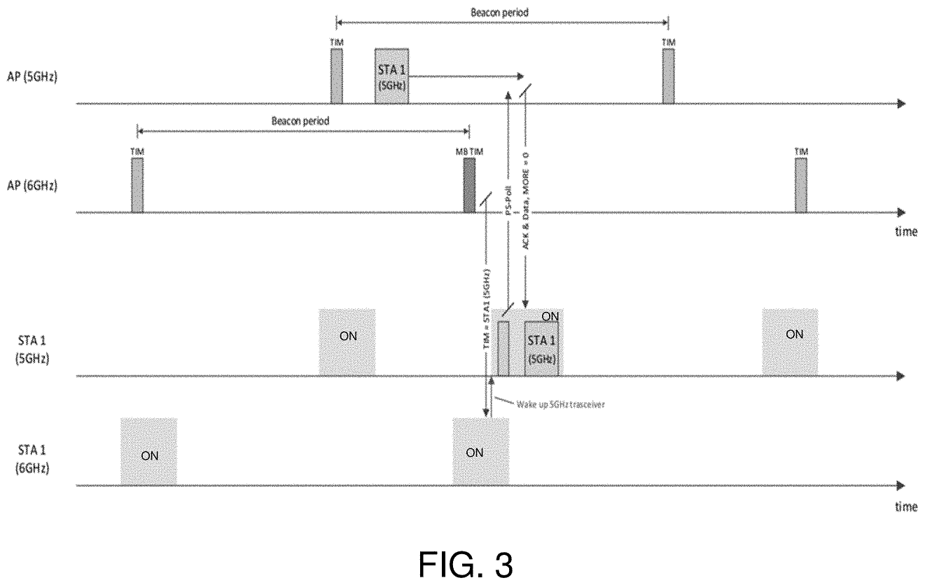

Referring to FIG. 3, there is shown an example behavior of the proposed multi-band power save mode (PSM) with piggybacked TIM information.

Consider a scenario where a multi-band-capable STA (denoted as “STA 1” in FIG. 3) is associated with a multi-band-capable AP on 5 GHz and 6-7 GHz bands. The STA has separate transceivers on 5 and 6-7 GHz band which operate independently to each other. In this scenario, both 5 and 6-7 GHz transceivers are in power save mode and asynchronously wake up to receive Beacon frames.

A) Behavior of the AP:

Assuming that STA 1 is on power save mode on both 5 GHz and 6-7 GHz bands, and supports the “Multi-band (MB) TIM” capability (see Section 5.1.D), the AP does the following.

When the AP receives data from the Internet which is destined to STA 1 on 5 GHz band, it checks the remaining time until the next scheduled Beacon frame transmissions on both operating bands.
If the Beacon transmission on 5 GHz band is scheduled before the Beacon transmission on 6 GHz band, then the AP buffers the data and sends a TIM on 5 GHz band (TIM_{5 GHz}) when it sends a Beacon frame on 5 GHz band.
If the Beacon transmission on 6 GHz band is scheduled before the Beacon transmission on 5 GHz band, then the AP piggybacks 5 GHz TIM in a Beacon transmitted on 6 GHz band, as shown in FIG. 3.

Once the AP receives a PS-poll frame from the STA on 5 GHz band, it sends the data to the STA.

B) Behavior of the STA:

In one or more embodiments, when the STA receives a Beacon frame, it searches for TIM element(s) in the received Beacon frame. If a multi-band TIM element(s) exists for a frequency band(s) which is not the current operating bandwidth, then the STA checks whether the TIM bitmap is set to “1” indicating there is data to receive from the AP. For example, if the STA receives an MB TIM element for 5 GHz band (TIM_{5 GHz}) in a Beacon frame transmitted on 6 GHz band, then the MAC RX processor on 6 GHz band checks whether there is any data to receive on 5 GHz band from the AP. For this, the “MB (multi-band) TIM” element can be defined to convey TIM information on other frequency bands. The “MB TIM” element can include the target frequency band information.

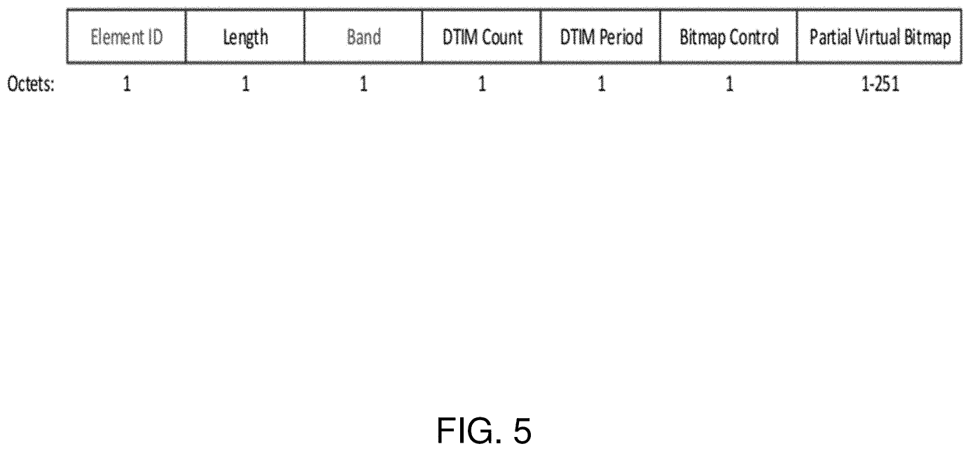

FIG. 5 shows an example of the proposed MB TIM element format. Note that the processing of MB TIM (e.g., TIM_{5 GHz}) is done in the current operating band without waking up the MAC processors of the other frequency band(s) to avoid unnecessarily waking up the other frequency bands. For this, the baseband MAC RX processors should be able to offload the logic for TIM element processing to each other and communicate such “MB TIM” capability to the AP.

If the TIM_{5 GHz} indicates that there is data to receive on 5 GHz band, then the MAC RX processor on 6 GHz band checks whether the 5 GHz band transceiver is in power save mode. Note that it may be assumed that baseband MAC processors on different bands can check power save mode status of the other bands in real-time via shared registers. If the 5 GHz band transceiver is in power save mode, then the MAC processor on 6 GHz band wakes up the 5 GHz band transceiver and signal that it received a TIM bitmap element set to “1” for the 5 GHz transceiver. The 5 GHz band transceiver wakes up from the sleep mode and sends a PS-poll frame to retrieve data from the AP. An example of basic PSM in Wi-Fi may be used, but the proposed multi-band TIM element can be used for other power save protocols such as TWT (Target Wake Time) or OPS (Opportunistic Power Save).

C) Multi-Band TIM Element:

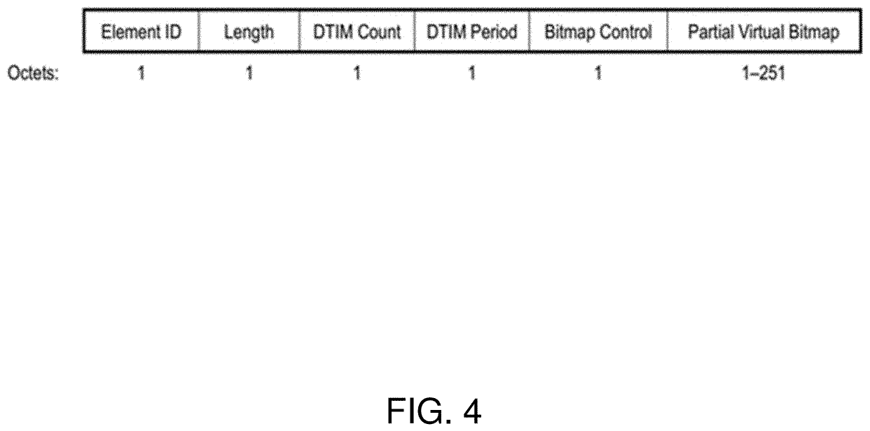

Referring to FIG. 4, there is shown a TIM element format as a reference.

Referring to FIG. 5, there is shown an example of the proposed “MB TIM” element format, where the “Element ID” is a new Element ID encoding that can be defined to indicate “MB TIM” using one of the Reserved values. Further, the “Band” field is a new subfield that can be defined to indicate the target frequency band. For example, an STA that receives a Beacon frame, or any other frame, comprising the multiband TIM element, the STA may determine from the Element ID that this TIM is for MB, and determine the “Band” field that will indicate to the STA that the target frequency band is associated with that TIM, which conveys the traffic information of that target frequency band.

D) Multi-Band TIM Capability Exchange:

In order to support multi-band TIM, STAs should be able to process MB TIM information element for other frequency band(s) and wake-up the other band(s) if needed. For this, STAs need to indicate such capability as part of the Capability Information Exchange during (Re)Association procedure. For this, a new “MB TIM Support” subfield can be defined in the MAC Capabilities Information field.

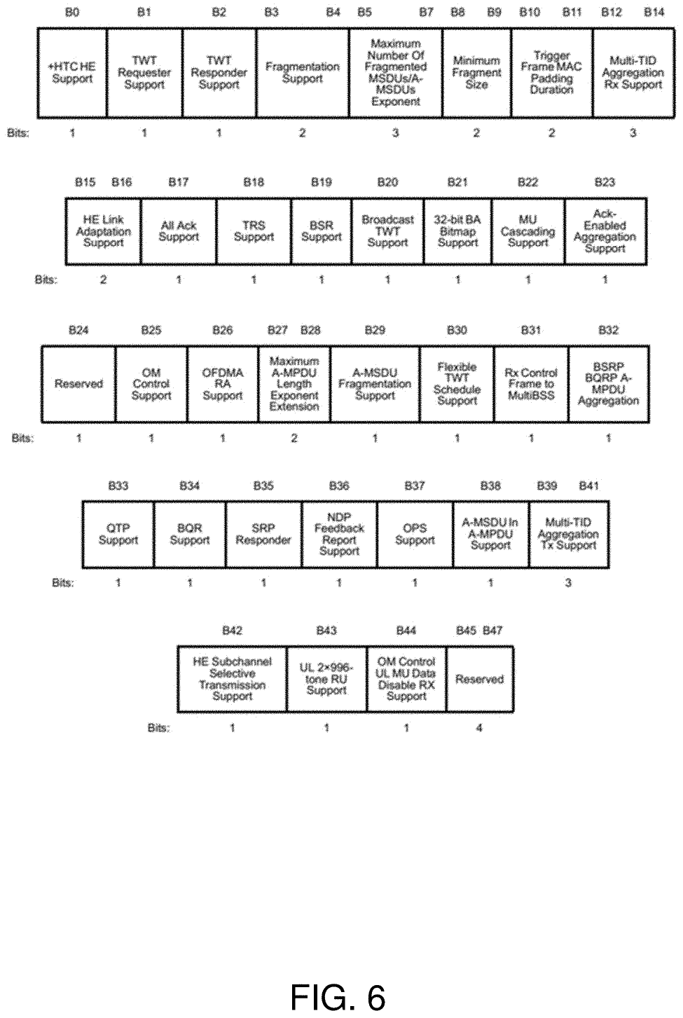

Referring to FIG. 6, there is shown the high efficiency (HE) MAC Capabilities Information field as a reference.

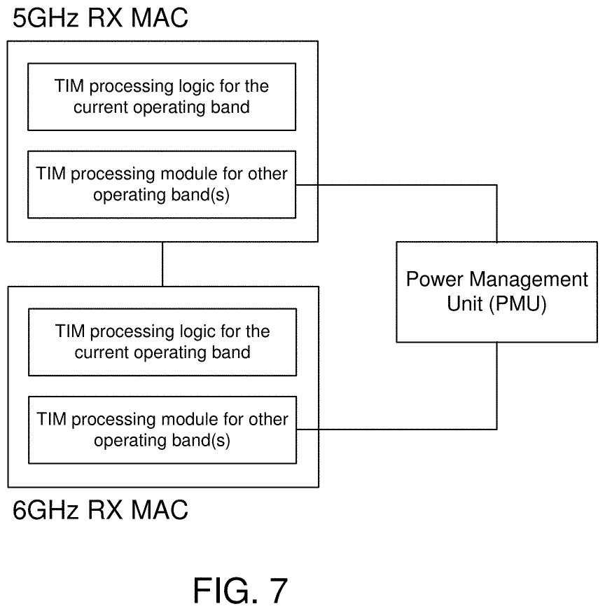

Referring to FIG. 7, there is shown a proposed MAC RX baseband architecture with MB-TIM-based wake-up capability.

In one or more embodiments, STAs with MB TIM capability should be able to process TIM information elements for other frequency bands and if needed wake up radios on other frequency bands. Therefore, the MAC RX baseband should have logics to process TIM information for other operating frequency bands, which can be offloaded (or configured) from the other bands via MAC-to-MAC communications. Based on the TIM information, it should be able to signal a wake-up signal to the power management unit (PMU) or alike to power up the other frequency band(s) and update their TIM information. It is understood that the above descriptions are for purposes of illustration and are not meant to be limiting.

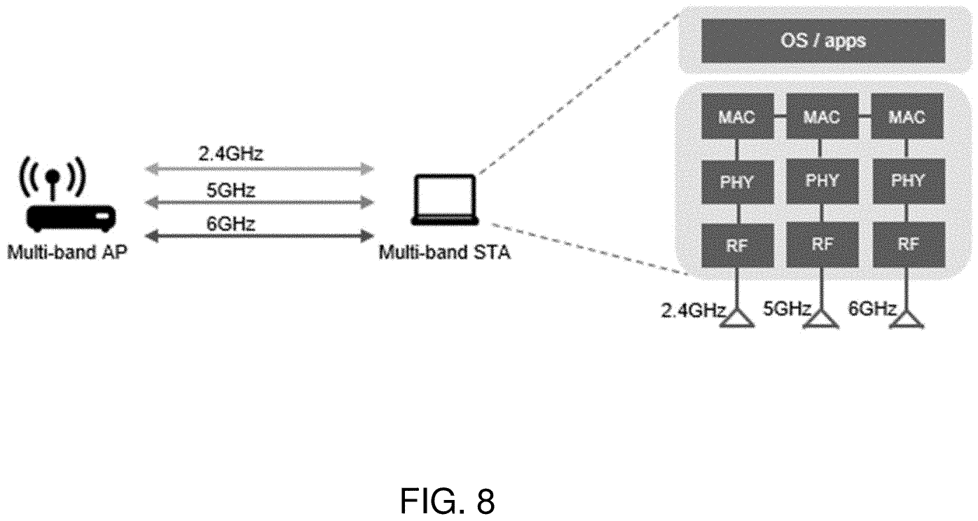

FIGS. 8-19 depict illustrative control processes, systems, and elements, in accordance with one or more example embodiments of the present disclosure.

FIG. 8 shows an example of MB Wi-Fi communication scenarios where an MB STA is associated with multi-band-capable AP over multiple frequency bands.

An MB-capable STA may be associated with an MB-capable AP over multiple frequency bands (e.g., 2.4, 5 and 6 GHz bands), as shown in FIG. 8. The MB AP and MB STA may exchange capability information regarding the list of supported bands during association, and use any of supported bands concurrently for frame exchanges based on their availability.

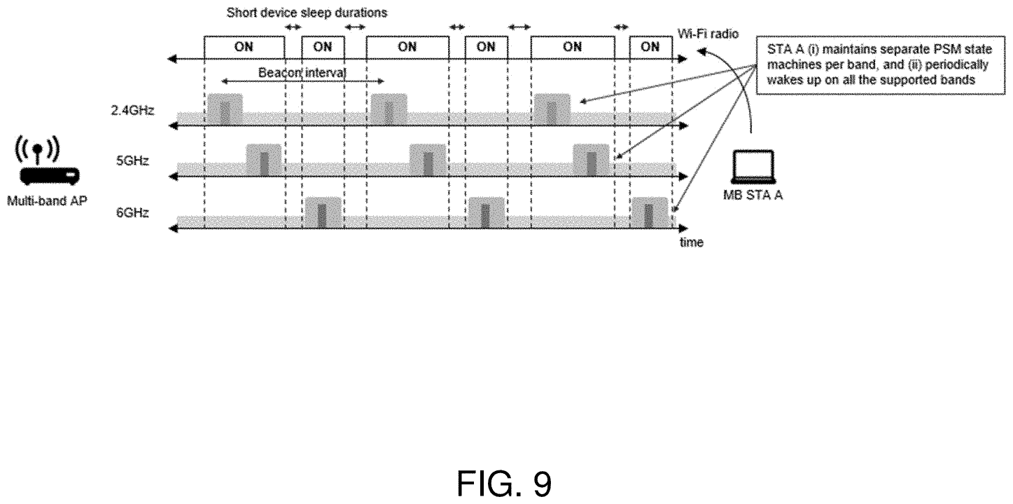

FIG. 9 shows baseline PSM behavior for MB Wi-Fi communications (e.g., reusing an IEEE 802.11 PSM for MB operations). In this example, MB STA A supports 3 frequency bands, i.e., 2.4, 5 and 6 GHz, and sends a Null Data frame with the PM (Power Management) bit set to “1” to indicate the transition to PSM. In PSM, the MB STA periodically wakes up on all the supported bands to receive Beacons transmitted on all of the supported bands. The MB AP sends a separate (per-band) TIM bitmap to indicate the presence of buffered data for the MB STA on each band. For example, the MB AP may choose to wake up a specific band to deliver data frames based on channel condition, TID, etc.

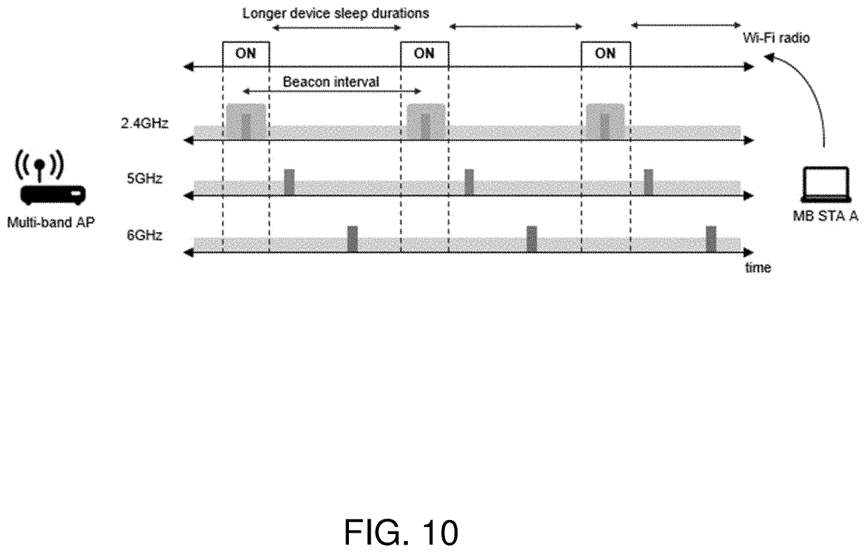

FIG. 10 shows the behavior of an enhanced PSM, which may allow MB STAs to receive AP TIM information on any of the supported bands where the TIM conveys traffic bitmap information for all the supported bands. Meanwhile, the STA transceivers on other bands may stay in low-power states for a longer period of time, as shown in FIG. 10.

To enable the enhanced MB PSM behavior in FIG. 10, one question to address is how to deliver the TIM to indicate the presence of buffered data on each supported band. For this, a new “MB (multi-band) TIM” element may be introduced to indicate band-specific TIM bitmap information. MB TIM may be included in Beacon frames in addition to the regular TIM element for the current operating band. For example, Beacon frames may include one regular TIM element for the current operating band (e.g., 2.4 GHz) and two additional MB TIM elements for 5 and 6 GHz bands. There are multiple ways to deliver TIM information for multiple frequency bands. Disclosed herein are ways to design MB TIM as examples and also a pre-negotiation-based method.

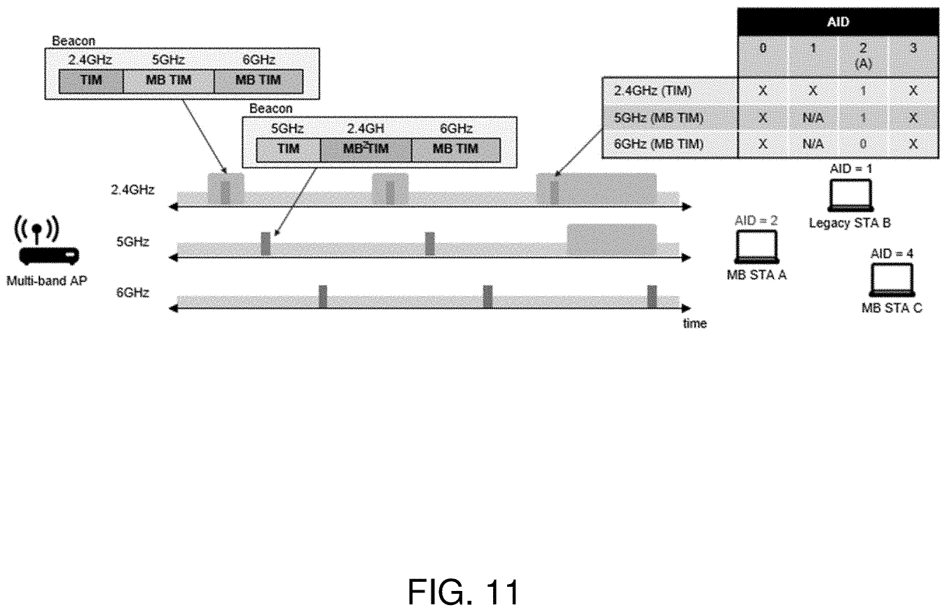

One way to deliver TIM on other frequency bands is to include separate TIMs per-band where TIM bitmaps in each band indicate the presence of buffered data on that band, as shown in FIG. 11. In FIG. 11, MB STA A is assigned “AID=2” and receives Beacon frames in 2.4 GHz band. Beacon frames in 2.4 GHz band convey a regular TIM element for 2.4 GHz band, and MB TIM elements for 5 and 6 GHz bands, which indicate the presence of buffered data for MB STA A on those bands. Upon receiving a Beacon frame, MB STA A (AID=2) wakes up frequency bands if the TIM bit allocated for AID=2 is set to “1” on those bands.

One advantage of this approach is that it is simple to implement because the same AID value may be used for each MB STA to indicate the presence of buffered data on different bands. However, this approach may result in a linear increase in total TIM bitmap size (e.g., 3× increase to support 3 bands) in Beacon frames, which can be up to 251 bytes.

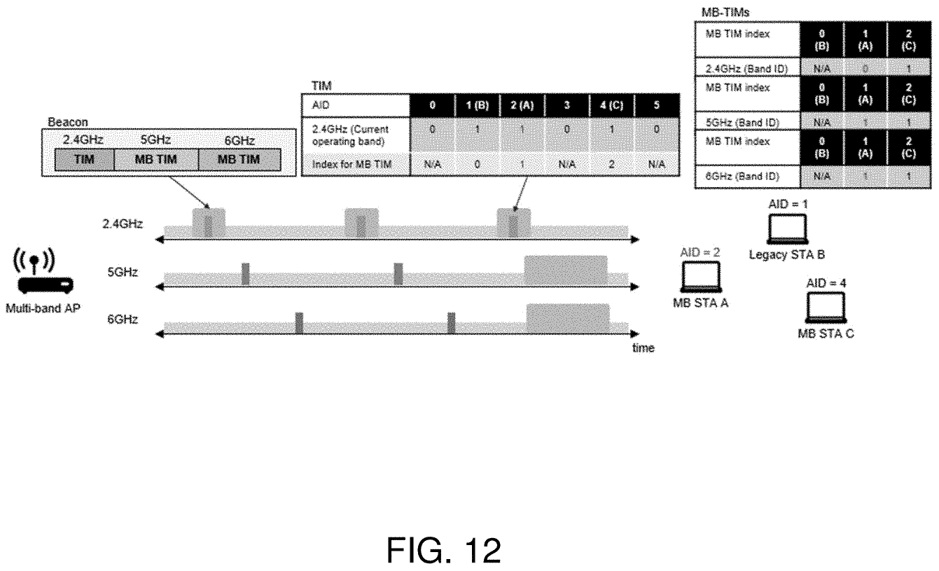

One way to minimize the overhead caused by including multiple TIM elements is to reduce the size of the bitmap in MB TIM elements. This can be done for example by constructing MB TIM bitmap only for the STAs with bitmap set to “1” in the regular TIM bitmap for the current band. The size of the MB TIM bitmap may be equal to the number of STAs with the bitmap set to “1” in the current frequency band, as shown in FIG. 12.

FIG. 12 shows a compressed MB TIM bitmap by creating a temporary index based on bitmap on the current frequency band:

For example, if the MB AP has buffered data for MB STA A on 5 and 6 GHz bands, then the AP may set the TIM bitmap to “1” on a current operating band (i.e., 2.4 GHz) to indicate that there is buffered data on at least one of its operating bands. Upon detecting the TIM bit set to “1” in the current operating band (i.e., 2.4 GHz TIM), MB STA A may calculate a temporary index for searching the MB TIM bitmap. The index may be an index of non-zero bits in the current TIM bitmap. For example, in FIG. 12, MB STA A is the second STA (AID) with a non-zero bit, so its index for MB TIM is 1. MB STA A may analyze the bits corresponding to index 1 in MB TIM bitmap to determine whether it has data to receive on each of the supported bands. This method may require MB APs and STAs to create a temporary index for each TIM element in Beacon, which may increase computation complexity, especially when the size of the TIM bitmap is large. Because the temporary index may be created for STAs with non-zero bits in TIM for the current operating band, MB TIM bitmaps may unnecessarily include entries for legacy STAs (e.g., STA B in FIG. 12) operating only on one band. This may reduce the compressibility and efficiency of the MB TIM bitmap.

Another way to design an MB TIM is to assign a separate (or secondary) AID to MB STAs which support more than one operating band. Such a secondary AID may be used for the purpose of indicating the presence of buffered data on other frequency bands when constructing the MB TIM bitmap. The assignment may be performed by allocating secondary AIDs to MB STAs using one of the “Reserved” bits in a 16-bit AID field.

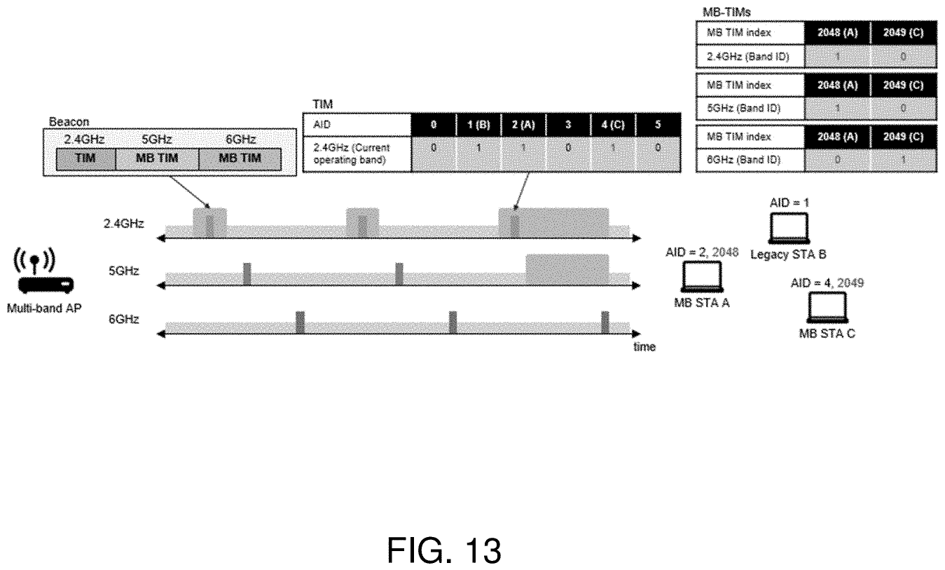

FIG. 13 shows a compressed MB TIM bitmap by allocating a secondary AID to MB STAs for the purpose of MB TIM bitmap creation.

In FIG. 13, the MB AP may only include the range of secondary AIDs allocated to MB STAs in MB TIM elements. By doing that, a TIM bitmap may be more compact and avoid potential waste by including entries to legacy STAs. In addition, MB APs may not need to change the meaning of the TIM bitmap in the current operating band.

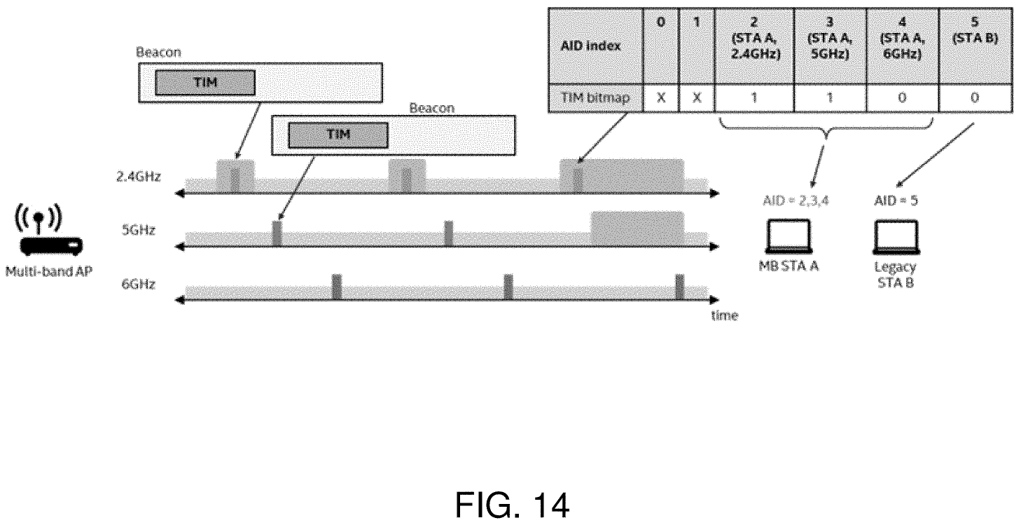

In another option, an MB AP may allocate more than one AID to an MB STA. For example, if the MB STA supports three bands (2.4, 5 and 6 GHz bands), the AP may allocate three consecutive AIDs, n, n+1, n+2 to the STA where AID=n is used in TIM bitmap to indicate the presence of data on 2.4 GHz band, n+1 for 5 GHz band, and n+2 for 6 GHz band, as shown in FIG. 14. With this scheme, a legacy TIM element may be used to indicate data on multiple bands. Because AIDs are consecutive numbers, the AIDs for 5 and 6 GHz bands may not need to be signaled to the STA in the Association Response frame. Instead, when the STA indicates that it supports m (m=1, 2, . . . ) bands, the AP needs to internally reserve m consecutive AIDs (n, n+1, . . . , n+m−1) for the STA and set the AID field in the Association Response frame to n. When the STA receives the Association Response frame, the STA assumes that m consecutive AIDs starting from n are assigned to the STA.

For example, in FIG. 14, the MB STA A is assigned AID=2, 3 and 4 for 2.4, 5 and 6 GHz bands, respectively. If the AP has buffered data to transmit to the STA on 2.4 and 5 GHz bands, the AP may set the TIM bitmap for AIDs 2 and 3 to “1”.

FIG. 14 shows the allocation of multiple AIDs to MB STAs to indicate the presence of buffered data per-band in TIM bitmap.

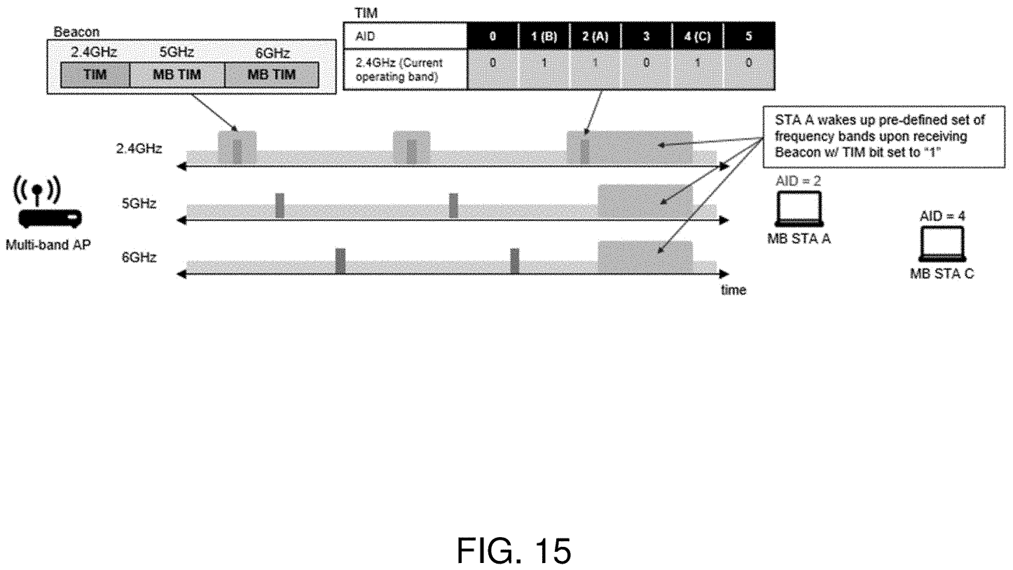

Another option is that MB APs and MB STAs may pre-negotiate wake-up bands before entering MB PSM through for example operating mode notification mechanism. When an MB AP has data to transmit to an MB STA, the MB AP sets the TIM bitmap to “1” in Beacons transmitted on all of the supported bands to indicate the presence of buffered data at the AP. Upon the reception of the Beacon with TIM bitmap to “1”, the MB STA will wake up a pre-negotiated list of frequency bands, as shown in FIG. 15.

FIG. 15 shows pre-negotiation-based MB PSM behavior.

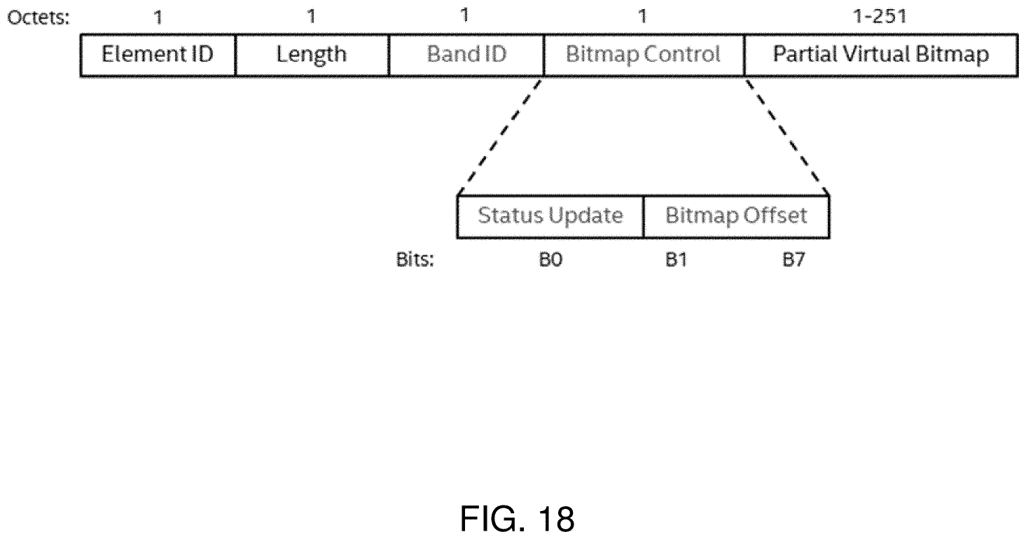

For the options in FIGS. 14 and 15, the MB AP may choose to include MB TIM element(s) to indicate any configuration changes on other bands (e.g., using the “Status Update” subfield shown below in FIG. 18), so that the MB STA may wake up on those bands and receive Beacons to apply band-specific configuration changes (e.g., enhanced distributed channel access EDCA parameters).

An example frame format for an enhanced MB TIM element is shown and may be relevant to any of the TIM options, including the option shown in FIG. 13.

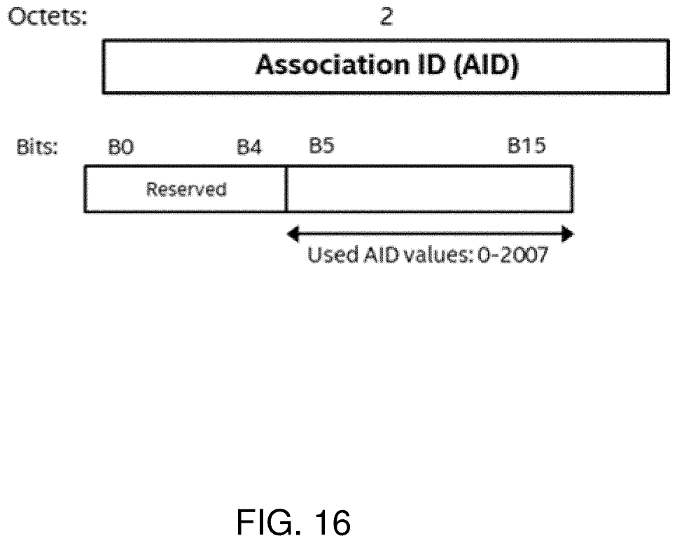

FIG. 16 shows the format of the AID field in an IEEE 802.11 technical specification. An AP may assign AID values 0-2007 and the 5-bit MSB is “Reserved.”

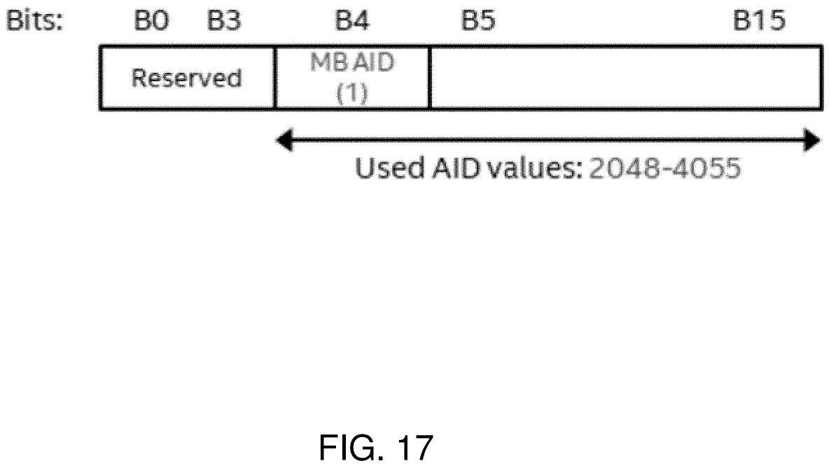

FIG. 17 shows a proposed format of the AID field where 1-bit “MB AID (B4)” subfield is introduced to indicate AID values allocated to MB STAs (for Option 3). For example, MB APs may set the “MB AID” bit to “1” and use the rest of the bits (B5-B15) to allocate AID values between 2048-4055. Other design options (e.g., as shown in FIGS. 4, 5, 7, and 8) may not require any changes to the AID field.

FIG. 18 shows a proposed format of the MB TIM element, which may include: (i) Band ID (1 Byte) subfield to indicate target frequency band. (ii) Status Update (1-bit) subfield in the “Bitmap Control” field to indicate any configuration changes in the target frequency band. If the “Status Update” bit is set to “1”, MB STAs may need to wake up on the target band to receive the next Beacon frame and apply any configuration changes. MB APs may need to convey configuration changes in multiple consecutive Beacon transmissions so that MB STAs may also receive those changes. (iii) Bitmap Offset (7-bit) subfield in the “Bitmap Control” field to indicate offset for MB AID. The bitmap field in the MB TIM element is to indicate the presence of buffered data exclusively for MB STAs. Therefore, the Offset value of 0 corresponds to the AID value of 2048 (for the option in FIG. 6).

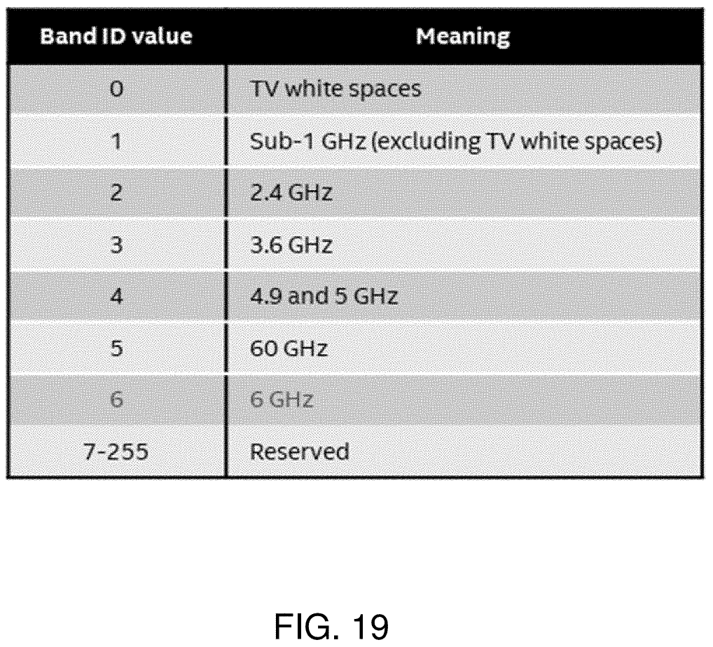

FIG. 19 shows an enhanced encoding rule for a “Band ID” field. Band ID value of 6 added to indicate a 6 GHz frequency band.

One remaining issue is how to deliver group-addressed frames to MB STAs when MB STAs may receive Beacons only on one band at a time. For example, in FIGS. 4-7, MB STA A is listening to Beacons on 2.4 GHz band, but there may be group-addressed frames on 5 and 6 GHz bands. In such a case, the MB AP may request that the MB STA A wake up on other bands to receive DTIM Beacon frames, even at the cost of increased power consumption. Alternatively, the MB AP may duplicate and transmit group-addressed frames after the DTIM Beacon on each band. By doing that, MB STAs can receive all of the group addressed frames on one band without needing to wake up other frequency bands once every DTIM period.

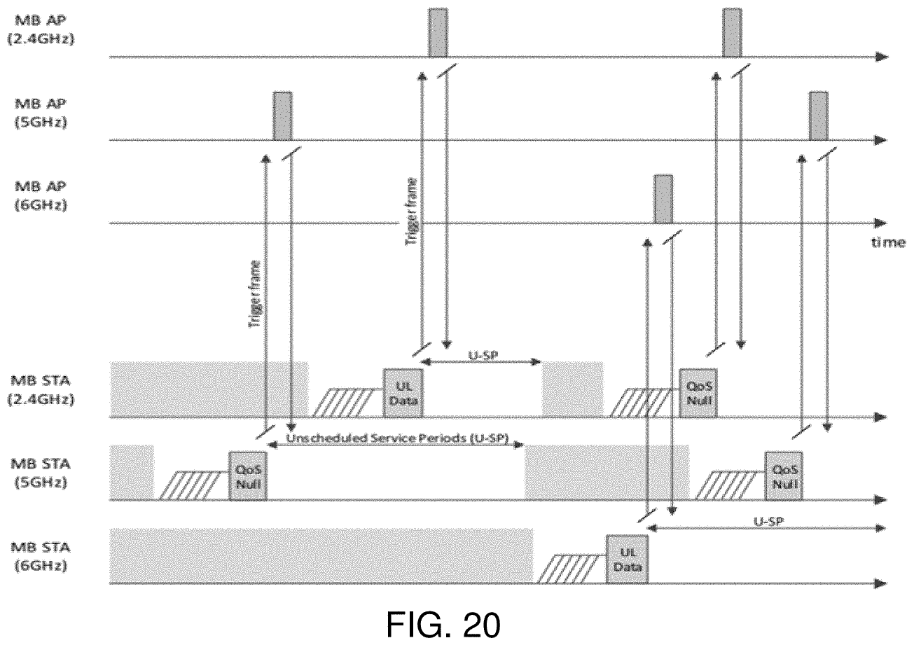

FIGS. 20-23 depict illustrative control processes, systems, and elements, in accordance with one or more example embodiments of the present disclosure.

Both next-generation Wi-Fi APs and STAs may be MB-capable, and such MB STAs may associate with MB APs over multiple frequency bands (e.g., 2.4, 5, 6 GHz), as shown in FIG. 1. An MB STA may exchange frames with an associated MB AP on any of the supported frequency bands.

In some scenarios, multi-band Wi-Fi communication may have a multi-band (MB) STA being associated with multi-band-capable AP over multiple frequency bands.

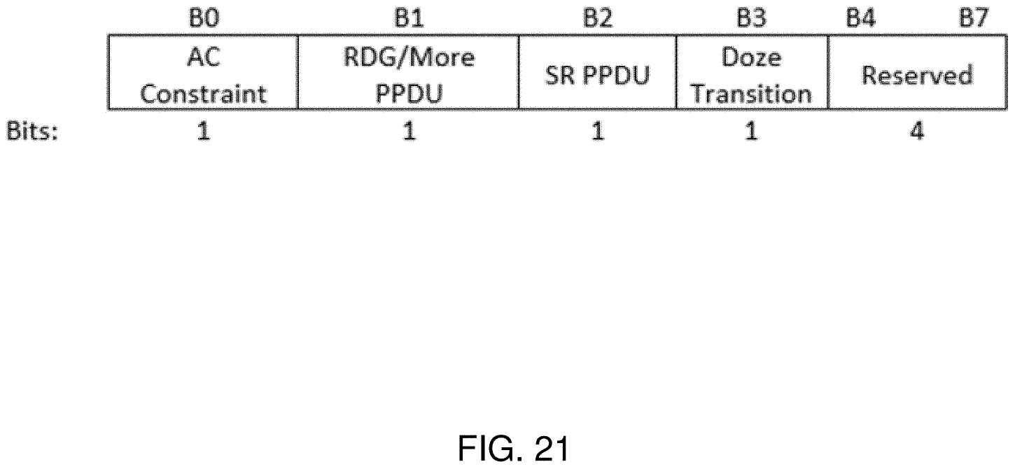

Such concurrent multi-band operations may consume more power. To reduce the power consumption, an MB STA may individually switch between the awake state and the doze state on each of the supported bands. For example, the MB STA may send a QoS Null frame or QoS Data frame to the MB AP to indicate that the band that the frame is transmitted is in the awake state and available to receive data from the AP, as shown in FIG. 21. However, applying such a mechanism to multi-band operation might not be sufficient in the sense that it cannot fully utilize all the available bands for signaling and it can incur unnecessary MAC overhead.

FIG. 20 shows an example of U-APSD in MB Wi-Fi communication scenarios.

The DTS signaling in A-control field shown in FIG. 21 can be piggybacked on to other control and data frames, thus reducing overhead. While the proposed DTS mechanism in 802.11ax allows an STA to opportunistically piggyback DTS indication on to other control/data frames, it may not be useful when there are no other on-going frame exchanges for piggybacking. Some DTS methods do not fully utilize the presence of multiple available frequency bands (e.g., 2.4, 5 and 6 GHz), which is envisioned in the IEEE EHT.

FIG. 21 shows the control information subfield for CAS control in A-Control field.

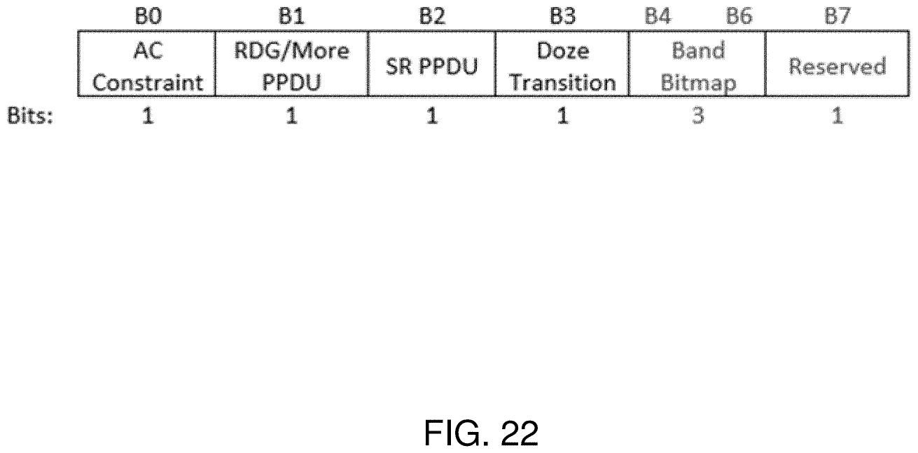

FIG. 22 illustrates a new Control Information subfield for the CAS control in the A-Control field. The new subfield uses three reserved bits for the Band Bitmap subfield to indicate which band is Awake in a trigger frame transmitted by an STA. The trigger frame is not the Trigger frame defined in the IEEE 802.11ax technical specification, but rather refers to a general term used in pre-802.11ax specifications).

The first bit of the Band Bitmap subfield is set to 1 if the STA is in the awake state in the 2.4 GHz band. Otherwise, the bit is set to 0. The second bit is set to 1 if the STA is in the awake state in the 5 GHz band. Otherwise, the bit is set to 0. The third bit is set to 1 if the STA is in the awake state in the 6 GHz band. Otherwise, the bit is set to 0.

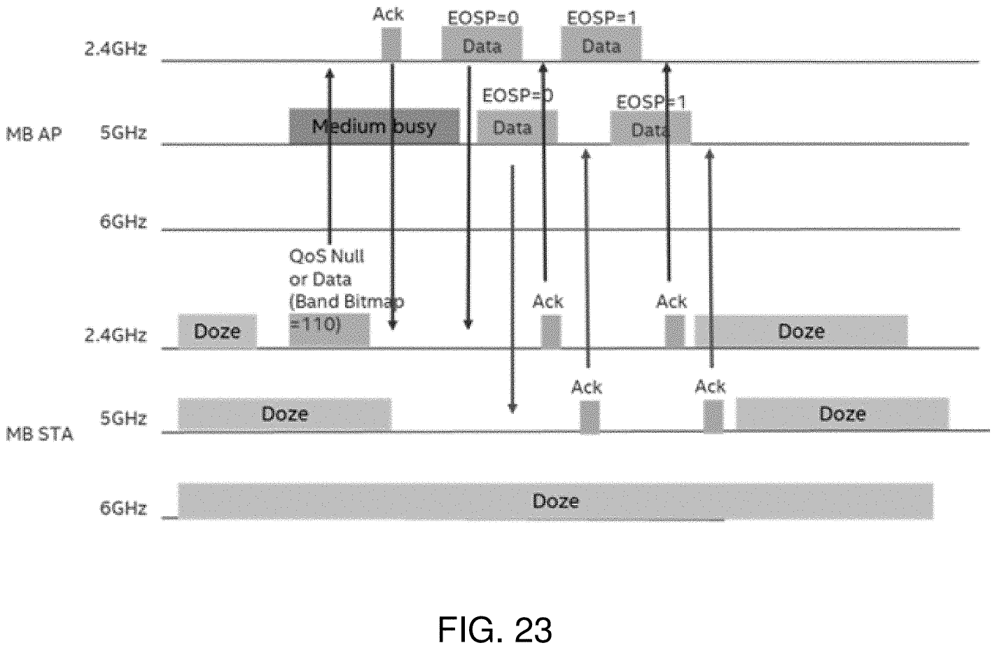

FIG. 23 illustrates the operation of the multi-band U-APSD.

The MB STA is initially in the doze state and wakes up and sends a QoS Null or QoS Data frame to the AP as a trigger frame on the band if it is awake. In this example, the MB STA is awake on the 2.4 GHz band and transmits a trigger frame on the 2.4 GHz band.

In the trigger frame, the Band Bitmap field is set to 110 or some other value to indicate that the MB STA is awake in 2.4 and 5 GHz bands. Upon receiving an ACK as a response to the trigger frame, MB STA's 5 GHz radio transitions to the awake state and ready to receive data from the AP on both 2.4 and 5 GHz bands. The 6 GHz band radio is still in the doze state in this example.

The MB AP executes the U-APSD procedure to deliver data frames to the MB STA. The EOSP (end of service period) bit or some other bit in the data frame is set to 0 or another value until the MB AP intends to terminate the unscheduled service period.

When the MB AP intends to end the service period, the MB AP sets the EOSP or another bit to 1 in the last data frame on a band in which the MB AP was transmitting. Upon reception of the data frame with the EOSP=1 on the band in the awake state and after transmitting an acknowledgment (Ack) frame to the AP, the MB STA may return to a doze state on the band.

It is understood that the above descriptions are for purposes of illustration and are not meant to be limiting.

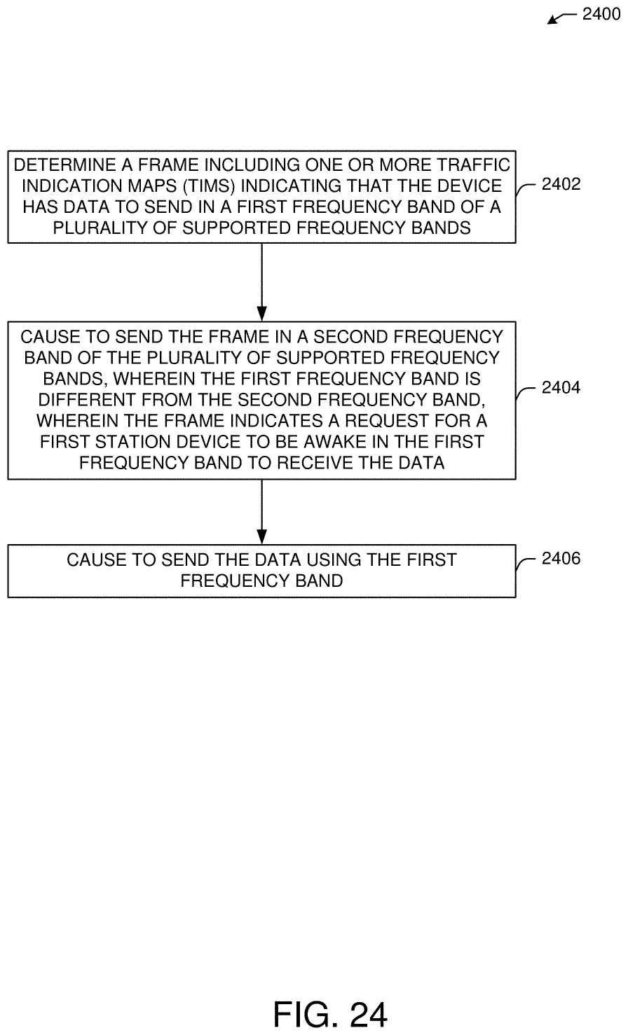

FIG. 24 illustrates a flow diagram of illustrative process 2400 for a traffic indication map piggybacking system, in accordance with one or more example embodiments of the present disclosure.

At block 2402, a device (e.g., the user device(s) 120 and/or the AP 102 of FIG. 1) may determine a frame including one or more traffic indication maps (TIMs) indicating that the device has data to send in a first frequency band of a plurality of supported frequency bands. The frame may further include an association identifier associated with the first station device. The one or more TIMs may include a first TIM and a second TIM, wherein the first TIM is associated with the first frequency band, and wherein the second TIM is associated with the second frequency band. A size of the one or more TIMs may be based on a number of the first station device operating in the second frequency band. The at least one of the one or more TIMs may convey traffic information of a target frequency band. The frame may further include a first association identifier associated with the first frequency band and a second association identifier associated with the second frequency band, wherein the first association identifier and the second association identifier are associated with a first station device radio of the first station device. The frame may comprise an Element ID indicating that the first TIM is for multi-band (MB), and wherein the frame further comprises a band field indicating to the first station device that a target frequency band is associated with the first TIM.

At block 2404, the device may cause to send the frame in a second frequency band of the plurality of supported frequency bands, wherein the first frequency band is different from the second frequency band, wherein the frame indicates a request for a first station device to be awake in the first frequency band to receive the data. The first station device may support multi-band operations, comprising two of more a 2.4 GHz band, a 5 GHz band, or a 6 GHz band.

At block 2406, the device may cause to send the data using the first frequency band.

It is understood that the above descriptions are for purposes of illustration and are not meant to be limiting.

FIG. 25 shows a functional diagram of an exemplary communication station 2500, in accordance with one or more example embodiments of the present disclosure. In one embodiment, FIG. 25 illustrates a functional block diagram of a communication station that may be suitable for use as an AP 102 (FIG. 1) or a user device 120 (FIG. 1) in accordance with some embodiments. The communication station 2500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 2500 may include communications circuitry 2502 and a transceiver 2510 for transmitting and receiving signals to and from other communication stations using one or more antennas 2501. The communications circuitry 2502 may include circuitry that can operate the physical layer (PHY) communications and/or medium access control (MAC) communications for controlling access to the wireless medium, and/or any other communications layers for transmitting and receiving signals. The communication station 2500 may also include processing circuitry 2506 and memory 2508 arranged to perform the operations described herein. In some embodiments, the communications circuitry 2502 and the processing circuitry 2506 may be configured to perform operations detailed in the above figures, diagrams, and flows.

In accordance with some embodiments, the communications circuitry 2502 may be arranged to contend for a wireless medium and configure frames or packets for communicating over the wireless medium. The communications circuitry 2502 may be arranged to transmit and receive signals. The communications circuitry 2502 may also include circuitry for modulation/demodulation, upconversion/downconversion, filtering, amplification, etc. In some embodiments, the processing circuitry 2506 of the communication station 2500 may include one or more processors. In other embodiments, two or more antennas 2501 may be coupled to the communications circuitry 2502 arranged for sending and receiving signals. The memory 2508 may store information for configuring the processing circuitry 2506 to perform operations for configuring and transmitting message frames and performing the various operations described herein. The memory 2508 may include any type of memory, including non-transitory memory, for storing information in a form readable by a machine (e.g., a computer). For example, the memory 2508 may include a computer-readable storage device, read-only memory (ROM), random-access memory (RAM), magnetic disk storage media, optical storage media, flash-memory devices and other storage devices and media.

In some embodiments, the communication station 2500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 2500 may include one or more antennas 2501. The antennas 2501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 2500 may include one or more of a keyboard, a display, a non-volatile memory port, multiple antennas, a graphics processor, an application processor, speakers, and other mobile device elements. The display may be an LCD screen including a touch screen.

Although the communication station 2500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 2500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 2500 may include one or more processors and may be configured with instructions stored on a computer-readable storage device.

FIG. 26 illustrates a block diagram of an example of a machine 2600 or system upon which any one or more of the techniques (e.g., methodologies) discussed herein may be performed. In other embodiments, the machine 2600 may operate as a standalone device or may be connected (e.g., networked) to other machines. In a networked deployment, the machine 2600 may operate in the capacity of a server machine, a client machine, or both in server-client network environments. In an example, the machine 2600 may act as a peer machine in peer-to-peer (P2P) (or other distributed) network environments. The machine 2600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 2600 may include a hardware processor 2602 (e.g., a central processing unit (CPU), a graphics processing unit (GPU), a hardware processor core, or any combination thereof), a main memory 2604 and a static memory 2606, some or all of which may communicate with each other via an interlink (e.g., bus) 2608. The machine 2600 may further include a power management device 2632, a graphics display device 2610, an alphanumeric input device 2612 (e.g., a keyboard), and a user interface (UI) navigation device 2614 (e.g., a mouse). In an example, the graphics display device 2610, alphanumeric input device 2612, and UI navigation device 2614 may be a touch screen display. The machine 2600 may additionally include a storage device (i.e., drive unit) 2616, a signal generation device 2618 (e.g., a speaker), a traffic indication map piggybacking device 2619, a network interface device/transceiver 2620 coupled to antenna(s) 2630, and one or more sensors 2628, such as a global positioning system (GPS) sensor, a compass, an accelerometer, or other sensor. The machine 2600 may include an output controller 2634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 2616 may include a machine readable medium 2622 on which is stored one or more sets of data structures or instructions 2624 (e.g., software) embodying or utilized by any one or more of the techniques or functions described herein. The instructions 2624 may also reside, completely or at least partially, within the main memory 2604, within the static memory 2606, or within the hardware processor 2602 during execution thereof by the machine 2600. In an example, one or any combination of the hardware processor 2602, the main memory 2604, the static memory 2606, or the storage device 2616 may constitute machine-readable media.

The traffic indication map piggybacking device 2619 may carry out or perform any of the operations and processes (e.g., process 2500) described and shown above.

It is understood that the above are only a subset of what the traffic indication map piggybacking device 2619 may be configured to perform and that other functions included throughout this disclosure may also be performed by the traffic indication map piggybacking device 2619.

While the machine-readable medium 2622 is illustrated as a single medium, the term “machine-readable medium” may include a single medium or multiple media (e.g., a centralized or distributed database, and/or associated caches and servers) configured to store the one or more instructions 2624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 2600 and that cause the machine 2600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 2624 may further be transmitted or received over a communications network 2626 using a transmission medium via the network interface device/transceiver 2620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 2620 may include one or more physical jacks (e.g., Ethernet, coaxial, or phone jacks) or one or more antennas to connect to the communications network 2626. In an example, the network interface device/transceiver 2620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 2600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

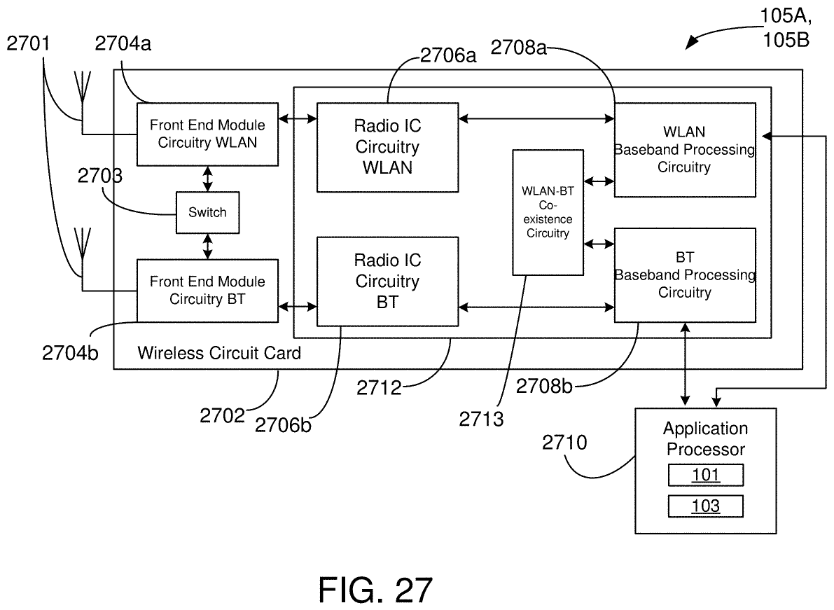

FIG. 27 is a block diagram of a radio architecture 105A, 105B in accordance with some embodiments that may be implemented in any one of the example AP 102 and/or the example user device 120 of FIG. 1. Radio architecture 105A, 105B may include radio front-end module (FEM) circuitry 2704a-b, radio IC circuitry 2706a-b and baseband processing circuitry 2708a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 2704a-b may include a WLAN or Wi-Fi FEM circuitry 2704a and a Bluetooth (BT) FEM circuitry 2704b. The WLAN FEM circuitry 2704a may include a receive signal path comprising circuitry configured to operate on WLAN RF signals received from one or more antennas 2701, to amplify the received signals and to provide the amplified versions of the received signals to the WLAN radio IC circuitry 2706a for further processing. The BT FEM circuitry 2704b may include a receive signal path which may include circuitry configured to operate on BT RF signals received from one or more antennas 2701, to amplify the received signals and to provide the amplified versions of the received signals to the BT radio IC circuitry 2706b for further processing. FEM circuitry 2704a may also include a transmit signal path which may include circuitry configured to amplify WLAN signals provided by the radio IC circuitry 2706a for wireless transmission by one or more of the antennas 2701. In addition, FEM circuitry 2704b may also include a transmit signal path which may include circuitry configured to amplify BT signals provided by the radio IC circuitry 2706b for wireless transmission by the one or more antennas. In the embodiment of FIG. 27, although FEM 2704a and FEM 2704b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 2706a-b as shown may include WLAN radio IC circuitry 2706a and BT radio IC circuitry 2706b. The WLAN radio IC circuitry 2706a may include a receive signal path which may include circuitry to down-convert WLAN RF signals received from the FEM circuitry 2704a and provide baseband signals to WLAN baseband processing circuitry 2708a. BT radio IC circuitry 2706b may in turn include a receive signal path which may include circuitry to down-convert BT RF signals received from the FEM circuitry 2704b and provide baseband signals to BT baseband processing circuitry 2708b. WLAN radio IC circuitry 2706a may also include a transmit signal path which may include circuitry to up-convert WLAN baseband signals provided by the WLAN baseband processing circuitry 2708a and provide WLAN RF output signals to the FEM circuitry 2704a for subsequent wireless transmission by the one or more antennas 2701. BT radio IC circuitry 2706b may also include a transmit signal path which may include circuitry to up-convert BT baseband signals provided by the BT baseband processing circuitry 2708b and provide BT RF output signals to the FEM circuitry 2704b for subsequent wireless transmission by the one or more antennas 2701. In the embodiment of FIG. 27, although radio IC circuitries 2706a and 2706b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 2708a-b may include a WLAN baseband processing circuitry 2708a and a BT baseband processing circuitry 2708b. The WLAN baseband processing circuitry 2708a may include a memory, such as, for example, a set of RAM arrays in a Fast Fourier Transform or Inverse Fast Fourier Transform block (not shown) of the WLAN baseband processing circuitry 2708a. Each of the WLAN baseband circuitry 2708a and the BT baseband circuitry 2708b may further include one or more processors and control logic to process the signals received from the corresponding WLAN or BT receive signal path of the radio IC circuitry 2706a-b, and to also generate corresponding WLAN or BT baseband signals for the transmit signal path of the radio IC circuitry 2706a-b. Each of the baseband processing circuitries 2708a and 2708b may further include physical layer (PHY) and medium access control layer (MAC) circuitry, and may further interface with a device for generation and processing of the baseband signals and for controlling operations of the radio IC circuitry 2706a-b.

Referring still to FIG. 27, according to the shown embodiment, WLAN-BT coexistence circuitry 2713 may include logic providing an interface between the WLAN baseband circuitry 2708a and the BT baseband circuitry 2708b to enable use cases requiring WLAN and BT coexistence. In addition, a switch 2703 may be provided between the WLAN FEM circuitry 2704a and the BT FEM circuitry 2704b to allow switching between the WLAN and BT radios according to application needs. In addition, although the antennas 2701 are depicted as being respectively connected to the WLAN FEM circuitry 2704a and the BT FEM circuitry 2704b, embodiments include within their scope the sharing of one or more antennas as between the WLAN and BT FEMs, or the provision of more than one antenna connected to each of FEM 2704a or 2704b.

In some embodiments, the front-end module circuitry 2704a-b, the radio IC circuitry 2706a-b, and baseband processing circuitry 2708a-b may be provided on a single radio card, such as wireless radio card 2702. In some other embodiments, the one or more antennas 2701, the FEM circuitry 2704a-b and the radio IC circuitry 2706a-b may be provided on a single radio card. In some other embodiments, the radio IC circuitry 2706a-b and the baseband processing circuitry 2708a-b may be provided on a single chip or integrated circuit (IC), such as IC 2712.

In some embodiments, the wireless radio card 2702 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 2708b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., SGPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

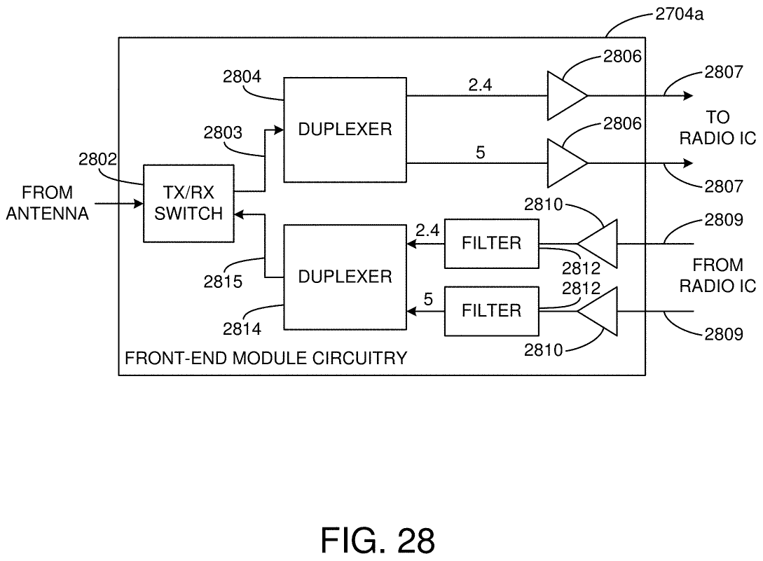

FIG. 28 illustrates WLAN FEM circuitry 2704a in accordance with some embodiments. Although the example of FIG. 28 is described in conjunction with the WLAN FEM circuitry 2704a, the example of FIG. 28 may be described in conjunction with the example BT FEM circuitry 2704b (FIG. 27), although other circuitry configurations may also be suitable.

In some embodiments, the FEM circuitry 2704a may include a TX/RX switch 2802 to switch between transmit mode and receive mode operation. The FEM circuitry 2704a may include a receive signal path and a transmit signal path. The receive signal path of the FEM circuitry 2704a may include a low-noise amplifier (LNA) 2806 to amplify received RF signals 2803 and provide the amplified received RF signals 2807 as an output (e.g., to the radio IC circuitry 2706a-b (FIG. 27)). The transmit signal path of the circuitry 2704a may include a power amplifier (PA) to amplify input RF signals 2809 (e.g., provided by the radio IC circuitry 2706a-b), and one or more filters 2812, such as band-pass filters (BPFs), low-pass filters (LPFs) or other types of filters, to generate RF signals 2815 for subsequent transmission (e.g., by one or more of the antennas 2701 (FIG. 27)) via an example duplexer 2814.

In some dual-mode embodiments for Wi-Fi communication, the FEM circuitry 2704a may be configured to operate in either the 2.4 GHz frequency spectrum or the 5 GHz frequency spectrum. In these embodiments, the receive signal path of the FEM circuitry 2704a may include a receive signal path duplexer 2804 to separate the signals from each spectrum as well as provide a separate LNA 2806 for each spectrum as shown. In these embodiments, the transmit signal path of the FEM circuitry 2704a may also include a power amplifier 2810 and a filter 2812, such as a BPF, an LPF or another type of filter for each frequency spectrum and a transmit signal path duplexer 2804 to provide the signals of one of the different spectrums onto a single transmit path for subsequent transmission by the one or more of the antennas 2701 (FIG. 27). In some embodiments, BT communications may utilize the 2.4 GHz signal paths and may utilize the same FEM circuitry 2704a as the one used for WLAN communications.

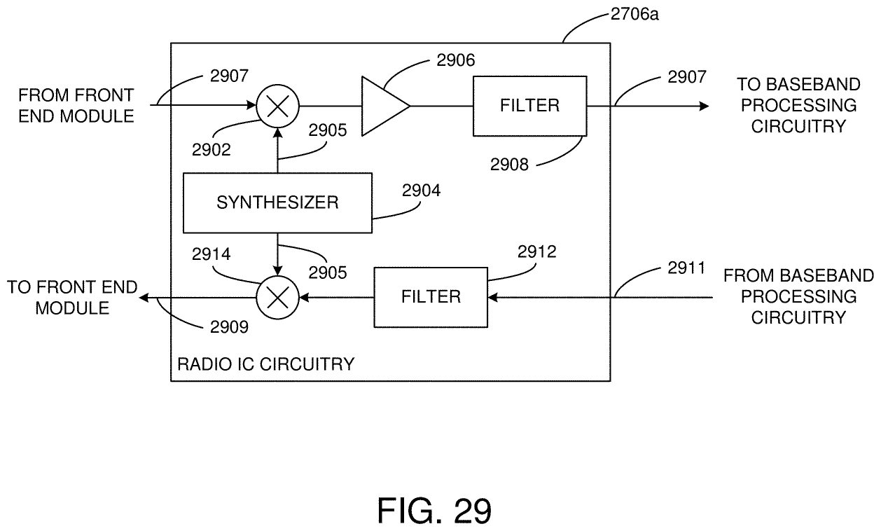

FIG. 29 illustrates radio IC circuitry 2706a in accordance with some embodiments. The radio IC circuitry 2706a is one example of circuitry that may be suitable for use as the WLAN or BT radio IC circuitry 2706a/2706b (FIG. 27), although other circuitry configurations may also be suitable. Alternatively, the example of FIG. 29 may be described in conjunction with the example BT radio IC circuitry 2706b.

In some embodiments, the radio IC circuitry 2706a may include a receive signal path and a transmit signal path. The receive signal path of the radio IC circuitry 2706a may include at least mixer circuitry 2902, such as, for example, down-conversion mixer circuitry, amplifier circuitry 2906 and filter circuitry 2908. The transmit signal path of the radio IC circuitry 2706a may include at least filter circuitry 2912 and mixer circuitry 2914, such as, for example, up-conversion mixer circuitry. Radio IC circuitry 2706a may also include synthesizer circuitry 2904 for synthesizing a frequency 2905 for use by the mixer circuitry 2902 and the mixer circuitry 2914. The mixer circuitry 2902 and/or 2914 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 29 illustrates only a simplified version of a radio IC circuitry, and may include, although not shown, embodiments where each of the depicted circuitries may include more than one component. For instance, mixer circuitry 2914 may each include one or more mixers, and filter circuitries 2908 and/or 2912 may each include one or more filters, such as one or more BPFs and/or LPFs according to application needs. For example, when mixer circuitries are of the direct-conversion type, they may each include two or more mixers.

In some embodiments, mixer circuitry 2902 may be configured to down-convert RF signals 2807 received from the FEM circuitry 2704a-b (FIG. 27) based on the synthesized frequency 2905 provided by synthesizer circuitry 2904. The amplifier circuitry 2906 may be configured to amplify the down-converted signals and the filter circuitry 2908 may include an LPF configured to remove unwanted signals from the down-converted signals to generate output baseband signals 2907. Output baseband signals 2907 may be provided to the baseband processing circuitry 2708a-b (FIG. 27) for further processing. In some embodiments, the output baseband signals 2907 may be zero-frequency baseband signals, although this is not a requirement. In some embodiments, mixer circuitry 2902 may comprise passive mixers, although the scope of the embodiments is not limited in this respect.

In some embodiments, the mixer circuitry 2914 may be configured to up-convert input baseband signals 2911 based on the synthesized frequency 2905 provided by the synthesizer circuitry 2904 to generate RF output signals 2809 for the FEM circuitry 2704a-b. The baseband signals 2911 may be provided by the baseband processing circuitry 2708a-b and may be filtered by filter circuitry 2912. The filter circuitry 2912 may include an LPF or a BPF, although the scope of the embodiments is not limited in this respect.

In some embodiments, the mixer circuitry 2902 and the mixer circuitry 2914 may each include two or more mixers and may be arranged for quadrature down-conversion and/or up-conversion respectively with the help of synthesizer 2904. In some embodiments, the mixer circuitry 2902 and the mixer circuitry 2914 may each include two or more mixers each configured for image rejection (e.g., Hartley image rejection). In some embodiments, the mixer circuitry 2902 and the mixer circuitry 2914 may be arranged for direct down-conversion and/or direct up-conversion, respectively. In some embodiments, the mixer circuitry 2902 and the mixer circuitry 2914 may be configured for super-heterodyne operation, although this is not a requirement.

Mixer circuitry 2902 may comprise, according to one embodiment: quadrature passive mixers (e.g., for the in-phase (I) and quadrature phase (Q) paths). In such an embodiment, RF input signal 2807 from FIG. 29 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 2905 of synthesizer 2904 (FIG. 29). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 2807 (FIG. 28) may comprise a balanced signal, although the scope of the embodiments is not limited in this respect. The I and Q baseband output signals may be provided to low-noise amplifier, such as amplifier circuitry 2906 (FIG. 29) or to filter circuitry 2908 (FIG. 29).

In some embodiments, the output baseband signals 2907 and the input baseband signals 2911 may be analog baseband signals, although the scope of the embodiments is not limited in this respect. In some alternate embodiments, the output baseband signals 2907 and the input baseband signals 2911 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 2904 may be a fractional-N synthesizer or a fractional N/N+1 synthesizer, although the scope of the embodiments is not limited in this respect as other types of frequency synthesizers may be suitable. For example, synthesizer circuitry 2904 may be a delta-sigma synthesizer, a frequency multiplier, or a synthesizer comprising a phase-locked loop with a frequency divider. According to some embodiments, the synthesizer circuitry 2904 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 2904 may be provided by a voltage controlled oscillator (VCO), although that is not a requirement. A divider control input may further be provided by either the baseband processing circuitry 2708a-b (FIG. 27) depending on the desired output frequency 2905. In some embodiments, a divider control input (e.g., N) may be determined from a look-up table (e.g., within a Wi-Fi card) based on a channel number and a channel center frequency as determined or indicated by the example application processor 2710. The application processor 2710 may include, or otherwise be connected to, one of the example secure signal converter 101 or the example received signal converter 103 (e.g., depending on which device the example radio architecture is implemented in).

In some embodiments, synthesizer circuitry 2904 may be configured to generate a carrier frequency as the output frequency 2905, while in other embodiments, the output frequency 2905 may be a fraction of the carrier frequency (e.g., one-half the carrier frequency, one-third the carrier frequency). In some embodiments, the output frequency 2905 may be a LO frequency (fLO).

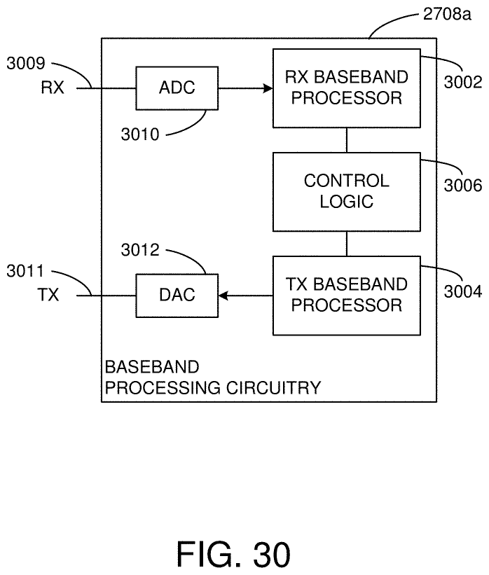

FIG. 30 illustrates a functional block diagram of baseband processing circuitry 2708a in accordance with some embodiments. The baseband processing circuitry 2708a is one example of circuitry that may be suitable for use as the baseband processing circuitry 2708a (FIG. 27), although other circuitry configurations may also be suitable. Alternatively, the example of FIG. 29 may be used to implement the example BT baseband processing circuitry 2708b of FIG. 27.

The baseband processing circuitry 2708a may include a receive baseband processor (RX BBP) 3002 for processing receive baseband signals 2909 provided by the radio IC circuitry 2706a-b (FIG. 27) and a transmit baseband processor (TX BBP) 3004 for generating transmit baseband signals 2911 for the radio IC circuitry 2706a-b. The baseband processing circuitry 2708a may also include control logic 3006 for coordinating the operations of the baseband processing circuitry 2708a.

In some embodiments (e.g., when analog baseband signals are exchanged between the baseband processing circuitry 2708a-b and the radio IC circuitry 2706a-b), the baseband processing circuitry 2708a may include ADC 3010 to convert analog baseband signals 3009 received from the radio IC circuitry 2706a-b to digital baseband signals for processing by the RX BBP 3002. In these embodiments, the baseband processing circuitry 2708a may also include DAC 3012 to convert digital baseband signals from the TX BBP 3004 to analog baseband signals 3011.

In some embodiments that communicate OFDM signals or OFDMA signals, such as through baseband processor 2708a, the transmit baseband processor 3004 may be configured to generate OFDM or OFDMA signals as appropriate for transmission by performing an inverse fast Fourier transform (IFFT). The receive baseband processor 3002 may be configured to process received OFDM signals or OFDMA signals by performing an FFT. In some embodiments, the receive baseband processor 3002 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 27, in some embodiments, the antennas 2701 (FIG. 27) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 2701 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: determine a frame including one or more traffic indication maps (TIMs) indicating that the device has data to send in a first frequency band of a plurality of supported frequency bands; cause to send the frame in a second frequency band of the plurality of supported frequency bands, wherein the first frequency band may be different from the second frequency band, wherein the frame indicates a request for a first station device to be awake in the first frequency band to receive the data; and cause to send the data using the first frequency band.

Example 2 may include the device of example 1 and/or some other example herein, wherein the first station device supports multi-band operations, comprising two of more a 2.4 GHz band, a 5 GHz band, or a 6 GHz band.

Example 3 may include the device of example 1 and/or some other example herein, wherein the frame further may include an association identifier associated with the first station device.

Example 4 may include the device of example 1 and/or some other example herein, wherein the one or more TIMs include a first TIM and a second TIM, wherein the first TIM may be associated with the first frequency band, and wherein the second TIM may be associated with the second frequency band.

Example 5 may include the device of example 1 and/or some other example herein, wherein a size of the one or more TIMs may be based on a number of the first station device operating in the second frequency band.

Example 6 may include the device of example 1 and/or some other example herein, wherein the frame further may include a first association identifier associated with the first frequency band and a second association identifier associated with the second frequency band, wherein the first association identifier and the second association identifier are associated with a first station device radio of the first station device.

Example 7 may include the device of example 4 and/or some other example herein, wherein the frame comprises an Element ID indicating that the first TIM may be for multi-band (MB), and wherein the frame further comprises a band field indicating to the first station device that a target frequency band may be associated with the first TIM.

Example 8 may include the device of example 1 and/or some other example herein, wherein the at least one of the one or more TIMs conveys traffic information of a target frequency band.

Example 9 may include a non-transitory computer-readable medium storing computer-executable instructions which when executed by one or more processors result in performing operations comprising: determine a frame including one or more traffic indication maps (TIMs) indicating that the device has data to send in a first frequency band of a plurality of supported frequency bands; cause to send the frame in a second frequency band of the plurality of supported frequency bands, wherein the first frequency band may be different from the second frequency band, wherein the frame indicates a request for a first station device to be awake in the first frequency band to receive the data; and cause to send the data using the first frequency band.

Example 10 may include the non-transitory computer-readable medium of example 1 and/or some other example herein, wherein the first station device supports multi-band operations, comprising two of more a 2.4 GHz band, a 5 GHz band, or a 6 GHz band.

Example 11 may include the non-transitory computer-readable medium of example 1 and/or some other example herein, wherein the frame further may include an association identifier associated with the first station device.

Example 12 may include the non-transitory computer-readable medium of example 1 and/or some other example herein, wherein the one or more TIMs include a first TIM and a second TIM, wherein the first TIM may be associated with the first frequency band, and wherein the second TIM may be associated with the second frequency band.

Example 13 may include the non-transitory computer-readable medium of example 1 and/or some other example herein, wherein a size of the one or more TIMs may be based on a number of the first station device operating in the second frequency band.

Example 14 may include the non-transitory computer-readable medium of example 1 and/or some other example herein, wherein the frame further may include a first association identifier associated with the first frequency band and a second association identifier associated with the second frequency band, wherein the first association identifier and the second association identifier are associated with a first station device radio of the first station device.

Example 15 may include the non-transitory computer-readable medium of example 4 and/or some other example herein, wherein the frame comprises an Element ID indicating that the first TIM may be for multi-band (MB), and wherein the frame further comprises a band field indicating to the first station device that a target frequency band may be associated with the first TIM.

Example 16 may include the non-transitory computer-readable medium of example 1 and/or some other example herein, wherein the at least one of the one or more TIMs conveys traffic information of a target frequency band.

Example 17 may include a method comprising: determine a frame including one or more traffic indication maps (TIMs) indicating that the device has data to send in a first frequency band of a plurality of supported frequency bands; cause to send the frame in a second frequency band of the plurality of supported frequency bands, wherein the first frequency band may be different from the second frequency band, wherein the frame indicates a request for a first station device to be awake in the first frequency band to receive the data; and cause to send the data using the first frequency band.

Example 18 may include the method of example 1 and/or some other example herein, wherein the first station device supports multi-band operations, comprising two of more a 2.4 GHz band, a 5 GHz band, or a 6 GHz band.

Example 19 may include the method of example 1 and/or some other example herein, wherein the frame further may include an association identifier associated with the first station device.

Example 20 may include the method of example 1 and/or some other example herein, wherein the one or more TIMs include a first TIM and a second TIM, wherein the first TIM may be associated with the first frequency band, and wherein the second TIM may be associated with the second frequency band.

Example 21 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 22 may include an apparatus comprising logic, modules, and/or circuitry to perform one or more elements of a method described in or related to any of examples 1-20, or any other method or process described herein.

Example 23 may include a method, technique, or process as described in or related to any of examples 1-20, or portions or parts thereof.

Example 24 may include an apparatus comprising: one or more processors and one or more computer readable media comprising instructions that, when executed by the one or more processors, cause the one or more processors to perform the method, techniques, or process as described in or related to any of examples 1-20, or portions thereof.

Example 25 may include a method of communicating in a wireless network as shown and described herein.

Example 26 may include a system for providing wireless communication as shown and described herein.

Example 27 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
determine a frame including one or more traffic indication maps (TIMs) indicating that the device has data to send in a first frequency band of a plurality of supported frequency bands;
cause to send the frame in a second frequency band of the plurality of supported frequency bands, wherein the first frequency band is different from the second frequency band, wherein the frame indicates a request for a first station device to be awake in the first frequency band to receive the data; and
cause to send the data using the first frequency band.

2. The device of claim 1, wherein the first station device supports multi-band operations, comprising two or more of a 2.4 GHz band, a 5 GHz band, or a 6 GHz band.

3. The device of claim 1, wherein the frame further includes an association identifier associated with the first station device.

4. The device of claim 1, wherein the one or more TIMs include a first TIM and a second TIM, wherein the first TIM is associated with the first frequency band, and wherein the second TIM is associated with the second frequency band.

5. The device of claim 1, wherein a size of the one or more TIMs is based on a number of the first station device operating in the second frequency band.

6. The device of claim 1, wherein the frame further includes a first association identifier associated with the first frequency band and a second association identifier associated with the second frequency band, wherein the first association identifier and the second association identifier are associated with a first station device radio of the first station device.

7. The device of claim 4, wherein the frame comprises an Element ID indicating that the first TIM is for multi-band (MB), and wherein the frame further comprises a band field indicating to the first station device that a target frequency band is associated with the first TIM.

8. The device of claim 1, wherein the at least one of the one or more TIMs conveys traffic information of a target frequency band.

9. A non-transitory computer-readable medium storing computer-executable instructions which when executed by one or more processors result in performing operations comprising:
determine a frame including one or more traffic indication maps (TIMs) indicating that the device has data to send in a first frequency band of a plurality of supported frequency bands;
cause to send the frame in a second frequency band of the plurality of supported frequency bands, wherein the first frequency band is different from the second frequency band, wherein the frame indicates a request for a first station device to be awake in the first frequency band to receive the data; and
cause to send the data using the first frequency band.

10. The non-transitory computer-readable medium of claim 9, wherein the first station device supports multi-band operations, comprising two or more of a 2.4 GHz band, a 5 GHz band, or a 6 GHz band.

11. The non-transitory computer-readable medium of claim 9, wherein the frame further includes an association identifier associated with the first station device.

12. The non-transitory computer-readable medium of claim 9, wherein the one or more TIMs include a first TIM and a second TIM, wherein the first TIM is associated with the first frequency band, and wherein the second TIM is associated with the second frequency band.

13. The non-transitory computer-readable medium of claim 9, wherein a size of the one or more TIMs is based on a number of the first station device operating in the second frequency band.

14. The non-transitory computer-readable medium of claim 9, wherein the frame further includes a first association identifier associated with the first frequency band and a second association identifier associated with the second frequency band, wherein the first association identifier and the second association identifier are associated with a first station device radio of the first station device.

15. The non-transitory computer-readable medium of claim 12, wherein the frame comprises an Element ID indicating that the first TIM is for multi-band (MB), and wherein the frame further comprises a band field indicating to the first station device that a target frequency band is associated with the first TIM.

16. The non-transitory computer-readable medium of claim 9, wherein the at least one of the one or more TIMs conveys traffic information of a target frequency band.

17. A method comprising:
determining a frame including one or more traffic indication maps (TIMs) indicating that the device has data to send in a first frequency band of a plurality of supported frequency bands;
causing to send the frame in a second frequency band of the plurality of supported frequency bands, wherein the first frequency band is different from the second frequency band, wherein the frame indicates a request for a first station device to be awake in the first frequency band to receive the data; and
causing to send the data using the first frequency band.

18. The method of claim 17, wherein the first station device supports multi-band operations, comprising two or more of a 2.4 GHz band, a 5 GHz band, or a 6 GHz band.

19. The method of claim 17, wherein the frame further includes an association identifier associated with the first station device.

20. The method of claim 17, wherein the one or more TIMs include a first TIM and a second TIM, wherein the first TIM is associated with the first frequency band, and wherein the second TIM is associated with the second frequency band.
